(19) United States
(12) Patent Application Publication
(10) Pub. No.: US 2016/0164725 A1
(43) Pub. Date: Jun. 9, 2016

(54) Wireless System Package and Communication Method of Wireless System Package and Communication Device

(71) Applicant: CYNTEC CO., LTD., Hsinchu (TW)

(72) Inventors: Tsung-Ta Wu, Hsinchu (TW); Yu-Chung Yang, Hsinchu (TW)

(21) Appl. No.: 14/945,440

(22) Filed: Nov. 19, 2015

Related U.S. Application Data
(60) Provisional application No. 62/089,193, filed on Dec. 8, 2014.

(51) Int. Cl. H04L 12/24; H04L 9/06; H04L 12/40; H04W 12/04; H04W 4/00; H04W 76/02

(52) U.S. Cl. CPC H04L 41/0803; H04W 4/008; H04W 76/02; H04L 12/40; H04W 12/04; H04L 9/0618; H04W 84/12

(57) ABSTRACT

A wireless system package includes a substrate, an external non-volatile memory, a first integrated circuit, and a second integrated circuit. The first integrated circuit includes a System on Chip unit, a bus, a first clock unit, a first terminal, a second terminal, and a third terminal. The second integrated circuit includes a second heterogeneous communication module, a second clock unit, a first terminal, and a second terminal. The first integrated circuit or the second integrated circuit includes a first heterogeneous communication module for providing and processing a first wireless signal. A capacity of the external non-volatile memory is larger than a capacity of the internal non-volatile memory.

### CROSS REFERENCE TO RELATED APPLICATIONS

This application claims the benefit of U.S. provisional application No. 62/089,193, filed Dec. 8, 2014.

### BACKGROUND OF THE INVENTION

1. Field of the Invention

The present invention illustrates a communication device, and more particularly, a communication device and wireless system package for configuring network status.

2. Description of the Prior Art

With the advancement of network and wireless technology, various machine to machine or human to machine systems are widely developed. For example, device can be controlled by a remote controller through a Wi-Fi (Wireless Fidelity) signal. The idea is to combine the electric device with a communication device to achieve remote control. Generally, a Wi-Fi configuration can be set up to these communication devices by the process of a Wi-Fi protect setup (WPS) and a Wi-Fi direct. In WPS configuration, the communication device requires a physical button which is manually pressed on the communication device for inputting a service set identifier (SSID), an access point (AP) identity, and a password automatically.

However, when the communication device uses the process of the WPS or the Wi-Fi direct for configuring all essential Wi-Fi connection parameters, several drawback or inconvenient issues exist and can be described as follows. In WPS configuration, when the communication device is located on a specific place such as an environment with high altitude, the physical button is difficult to press manually. Further, the WPS configuration only provides a basic connection mode since the WPS configuration is a button-based setup process. An advanced connection mode (i.e., for example, IP addressing set up) is not supported by the WPS configuration. In the Wi-Fi direct configuration, when the communication device initially activates the Wi-Fi direct function or performs a handover process, it suffers severe power consumption. These issues will limit the interest and the applicability of communication device.

Further, conventional communication device is lack of a security protection method for avoiding unlicensed copy (i.e., pirate copy). Since no unique cipher is used to encrypt a secret message and make it unreadable unless the recipient knows the secret to decrypt it, conventional communication device may be duplicated in forms of unlicensed, illegal, or pirate manufacture.

Besides, when the conventional communication device is designed with multi-modes communication operations, such as Wi-Fi station mode and Wi-Fi AP mode, the communication device requires high specification hardware. For example, SOC (System on Chip) unit having a Cortex-M3 micro-processor unit with high power consumption in conjunction with large capacity built-in flash memory or SRAM is required to perform multi-modes communication operation. As a result, layout size has to be large leading to high power consumption. Additionally, large capacity built-in flash memory leads severe power consumption.

Furthermore, since radio frequency (RF) signals of Wi-Fi or others are high-frequency signals, electromagnetic interference (EMI) or local oscillator (LO) leakage may be easily occurred. EMI or LO leakage may interrupt, obstruct or otherwise degrade or limit the effective performance of the circuit. As is known in the art, wireless communication devices design must considered with antenna and wireless components of the wireless function circuit to reduce EMI or LO leakage. However, the wireless function circuit is not formed as a module or package, and plural wireless components of the wireless function circuit are designed to be disposed on the system circuit board. It is well-known that layer number, thickness or materials of the system circuit board of the wireless communication devices are different from each other. Consequently, it is the arrangement of the antenna, layout of PCB and wireless components of the wireless function circuit cannot be more complex to apply to other wireless communication devices for achieving the same wireless performance.

Thus, to develop a communication device having multi-modes communication operation, convenient usage, support for advanced connection mode, or low power consumption is an important issue.

### SUMMARY OF THE INVENTION

In an embodiment of the present invention, a wireless system package is disclosed. The wireless system package includes a substrate, an external non-volatile memory, a first integrated circuit, and a second integrated circuit. The substrate includes at least one layout, a plurality of pin pads on a bottom side of the substrate, a plurality of contact pads, and at least one via. The external non-volatile memory is disposed on the substrate and coupled to the partial contact pads. The first integrated circuit is disposed on the substrate and coupled to the partial contact pads. The first integrated circuit includes a System on Chip unit, a bus, a first clock unit, a first terminal, a second terminal, and a third terminal. The System on Chip unit includes a processor, an internal volatile memory, and an internal non-volatile memory. The bus is coupled to the System on Chip unit. The first clock unit is configured to process a first clock from a first oscillator. The first terminal is coupled to the bus. The second terminal is coupled to the bus and the partial pin pads through at least one layout and is configured to transmit and receive SOC data. The third terminal is coupled to the System on Chip unit and a terminal of an external non-volatile memory through at least one layout. A second integrated circuit is disposed on the substrate and coupled to the partial contact pads. The second integrated circuit includes a second heterogeneous communication module, a second clock unit, a first terminal, and a second terminal. The second clock unit is used for processing a second clock from a second oscillator. The first terminal is coupled to the second heterogeneous communication module and the first terminal of the first integrated circuit through a layout of the substrate or a layout of a system printed circuit board (PCB). The second terminal is coupled to the second heterogeneous communication module and is used for transmitting and receiving a second wireless signal. The first integrated circuit or the second integrated circuit includes a first heterogeneous communication module for providing and processing a first wireless signal. A capacity of the external non-volatile memory is larger than a capacity of the internal non-volatile memory.

In another embodiment of the present invention, a communication method for a communication device or a wireless system package is disclosed. The communication method for a communication device or a wireless system package includes the communication device or the wireless system package broadcasting an advertising signal, the communication device or the wireless system package receiving a plurality of second parameters by Bluetooth corresponding to a second Wi-Fi (Wireless Fidelity) connection status from a first connection terminal or a second connection terminal, and the communication device or the wireless system package establishing a connection Wi-Fi link to a second connection terminal according to the plurality of second parameters corresponding to the second Wi-Fi connection status.

In another embodiment of the present invention, a communication method for a communication device or a wireless system package is disclosed. The communication method for a communication device or a wireless system package includes broadcasting a Wi-Fi Beacon signal, receiving and advertising signal of Bluetooth from other communication device or wireless system package, establishing a Bluetooth connection to the other communication device or wireless system package, transmitting a plurality of second parameters by Bluetooth to the other communication device or wireless system package, receiving a Wi-Fi (Wireless Fidelity) request signal with respect to the plurality of second parameters from the other communication device or wireless system package, and verifying link validities and allowing to establish a Wi-Fi connection to the other communication device or wireless system package.

In another embodiment of the present invention, a security protection method for a communication device or a wireless system package is disclosed. The method includes reading out a first serial number uniquely coded from a first component of the communication device or the wireless system package, reading out a second serial number uniquely coded from a second component of the communication device or the wireless system package, reading out an ciphertext codeword from an non-volatile memory, comparing or verifying a consistency between a first correlation and a second correlation, and when the first correlation and the second correlation are inconsistency, disabling an operation of the communication device or the wireless system package. The first correlation is a correlation between the first serial number and the second serial number in a current hardware, the second correlation is a correlation between a first serial number and a second serial number with the ciphertext codeword saved in the non-volatile memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic block diagram of a wireless system package according to an embodiment of the present invention.

FIG. 1A illustrates a block diagram of a first type of wireless system package.

FIG. 1B illustrates a block diagram of a second type of wireless system package.

FIG. 1C illustrates a block diagram of a third type of wireless system package.

FIG. 1D illustrates a block diagram of a fourth type of wireless system package.

FIG. 2A illustrates a front view of components placement of the wireless system package in FIG. 1.

FIG. 2B illustrates a bottom view of pin pad of the wireless system package in FIG. 1.

FIG. 2C illustrates a cross-sectional view of the structure of the wireless system package in FIG. 1.

FIG. 3 is a schematic block diagram of a wireless system package according to another embodiment of the present invention.

FIG. 4 illustrates a network structure according to an embodiment of the present invention.

FIG. 5 illustrates a user interface of application program of a communication terminal according to an embodiment of the present invention.

FIG. 5A illustrates an interface with configuration acquirement according to an embodiment of the present invention.

FIG. 6 illustrates a communication method among the communication device with the wireless system package in FIG. 1 and two communication terminals according to an embodiment of the present invention.

FIG. 6A illustrates a flow chart of a communication process of the communication device with the wireless system package.

FIG. 6B illustrates a flow chart of a communication process of a second connection terminal.

FIG. 7 illustrates a message propagation method of the communication device with the wireless system package in FIG. 1 according to an embodiment of the present invention.

FIG. 7A illustrates a flow chart of the connection process of the communication device with the wireless system package 100a in FIG. 7.

FIG. 8 illustrates a schematic block diagram of a wireless system package according to another embodiment of the present invention.

FIG. 9 illustrates a flow chart of multi-mode selection process of the wireless system package in FIG. 8 according to an embodiment of the present invention.

FIG. 10 illustrates a schematic block diagram of the wireless system package according to another embodiment of the present invention.

FIG. 11 illustrates a security protection method for the wireless system package in FIG. 10 by encryption to generate a ciphertext codeword according to an embodiment of the present invention.

FIG. 11A illustrates merging processes for security protection method in FIG. 11.

FIG. 12 illustrates a security protection method for the wireless system package in FIG. 10 by verifying the ciphertext codeword according to an embodiment of the present invention.

FIG. 13 illustrates a schematic block diagram of a wireless system package according to another embodiment of the present invention.

FIG. 14 illustrates a comparison between conventional communication devices and the wireless system package in FIG. 1.

### DETAILED DESCRIPTION

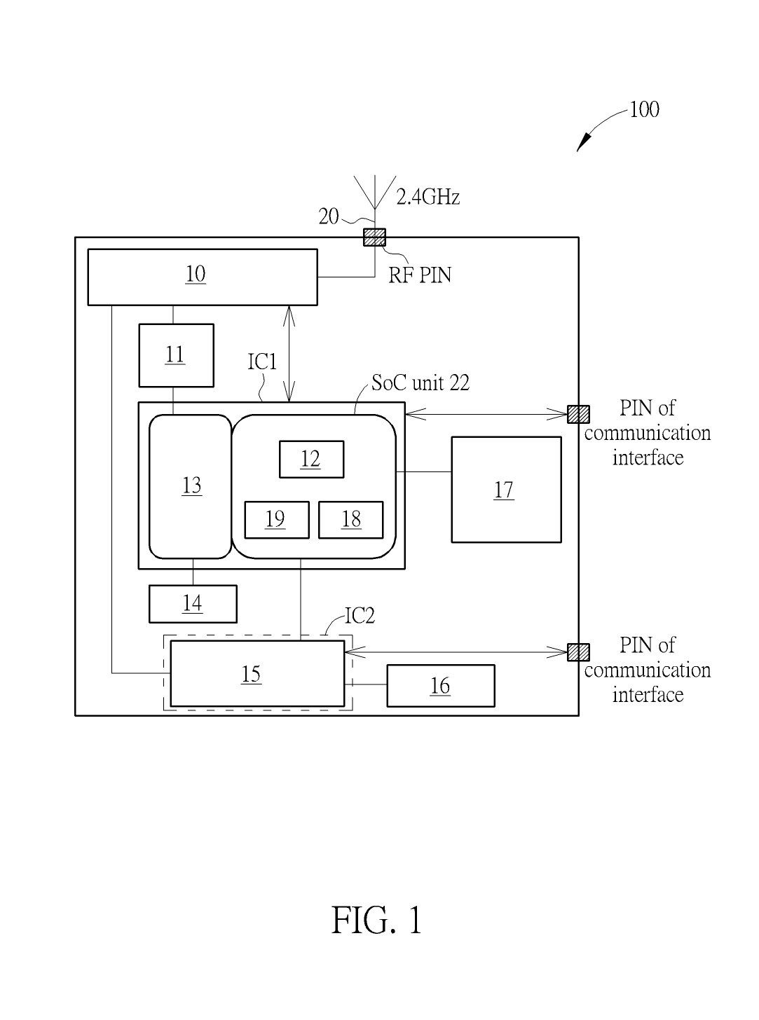

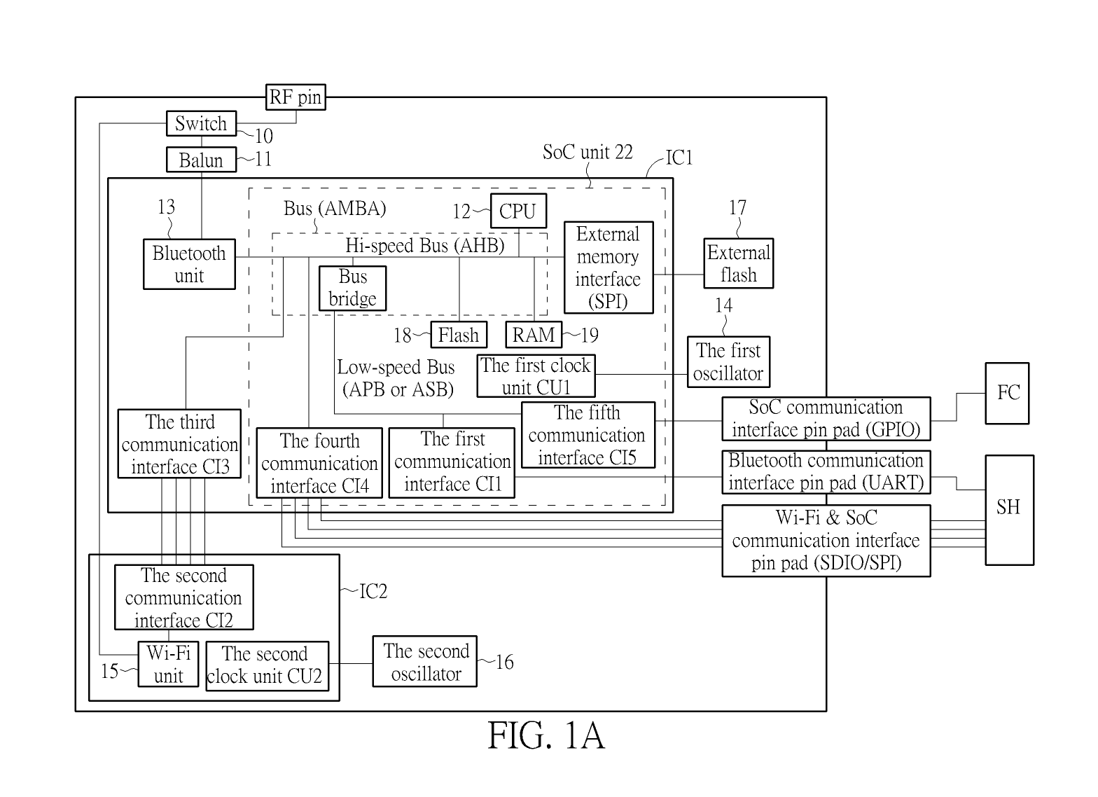

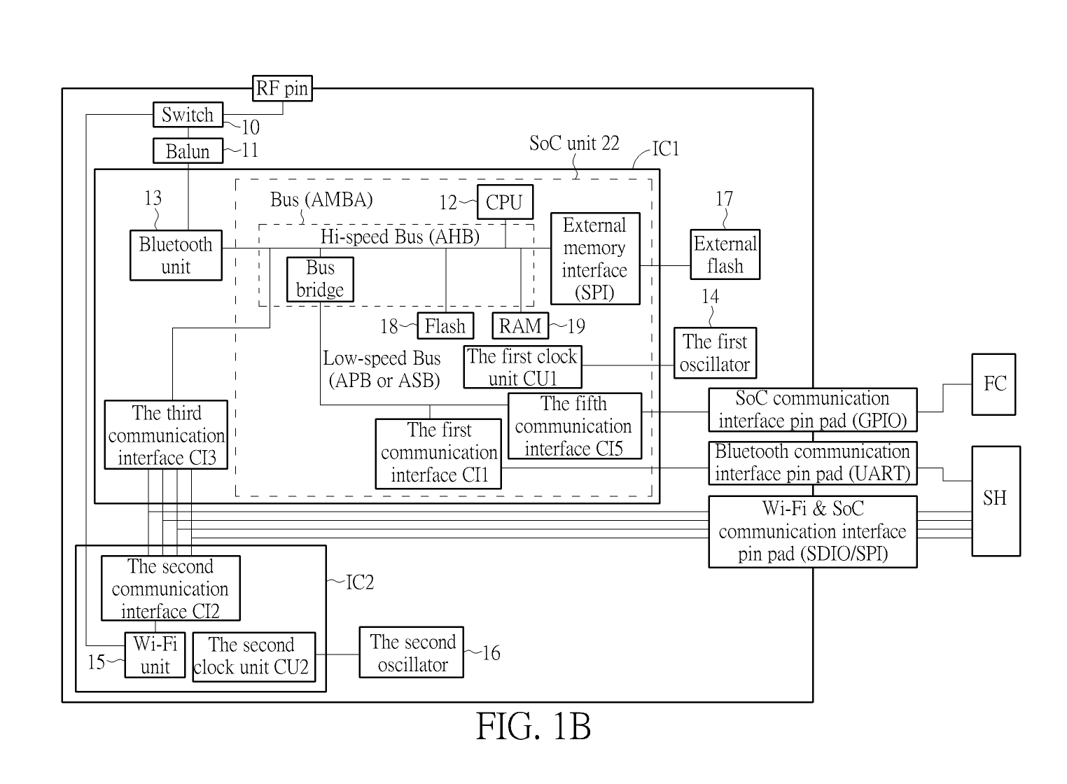

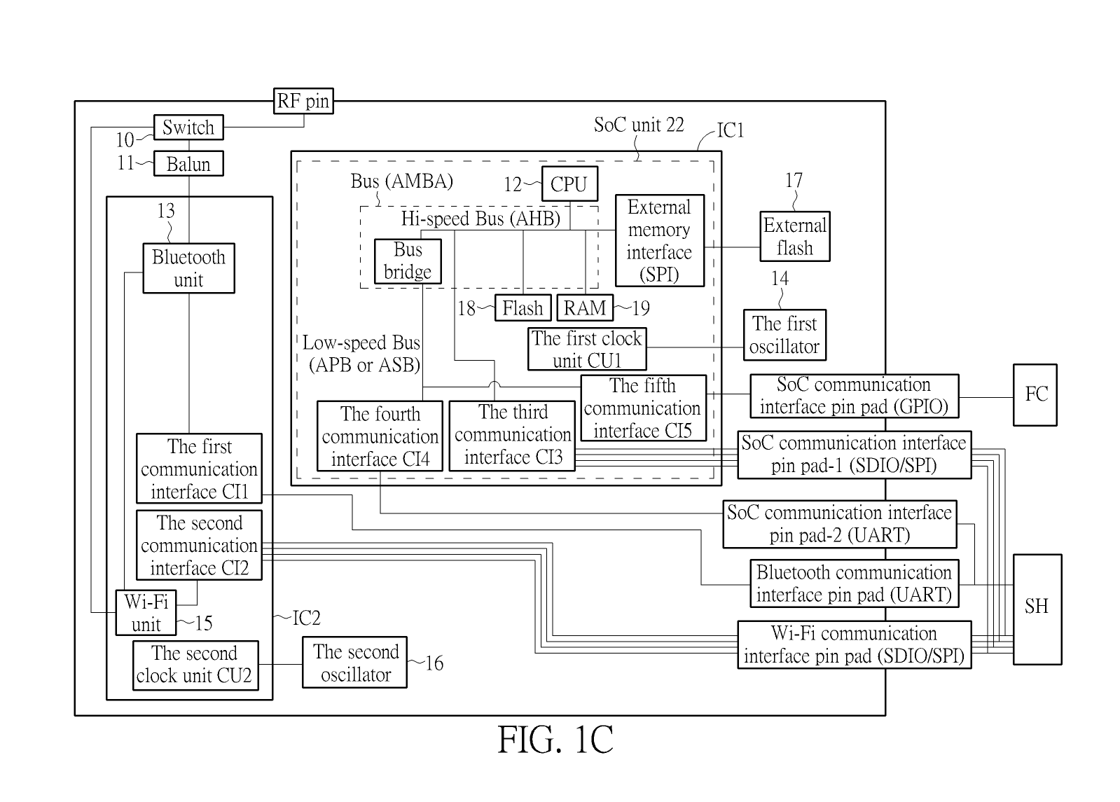

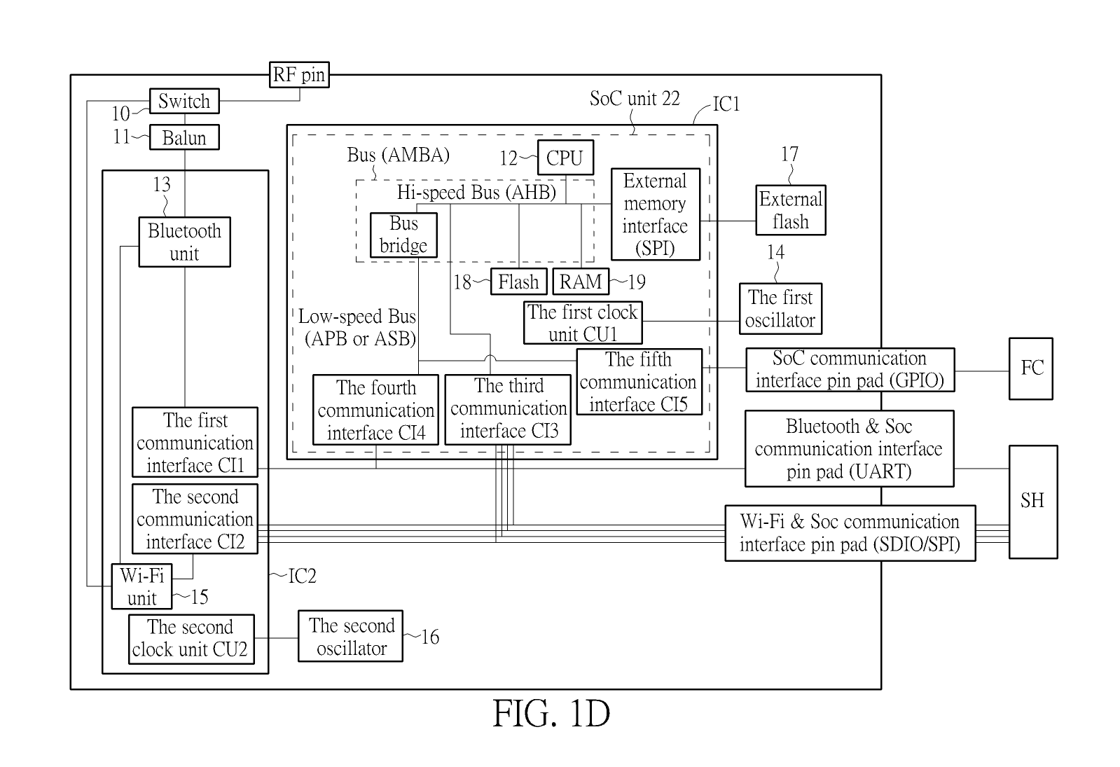

FIG. 1 illustrates a schematic block diagram of a wireless system package 100 (i.e., the application can be communication device) according to an embodiment of the present invention. As shown in FIG. 1, the wireless system package 100 includes a radio frequency (RF) switch 10. Specifically, in this embodiment, two heterogeneous wireless signals or RF signals (i.e., Bluetooth and Wi-Fi signals) are transmitted or received by a common antenna 20 through RF switch 10. In other embodiment, when the two heterogeneous wireless signals are respectively transmitted or received by two antennas, the RF switch 10 can be omitted. The wireless system package 100 further includes a Balun 11. In the embodiment, a Balun 11 is used for transformation between balanced and un-balanced signal. When an LVDS (Low-voltage differential signaling) signal is used by the integrated circuit of wireless system package 100, the Balun 11 is required to transform the LVDS signal to a single signal. The wireless system package 100 further includes SOC (System on Chip) unit 22 (it can also be an MCU) having a processor 12, an internal volatile memory 18 and an internal non-volatile memory 19. Particularly, the processor 12 is integrated on the SOC unit 22 of the wireless system package 100. For example, the SOC unit 22 includes the processor 12 (ARM Cortex M0 CPU with low power consumption), an internal RAM (Random Access Memory, denoted by the internal volatile memory 18), an internal storage (Flash, denoted by a the internal non-volatile memory 19). The wireless system package 100 further includes a Bluetooth module 13, a first oscillator 14, a Wi-Fi (Wireless Fidelity) module 15, a second oscillator 16, an external non-volatile memory 17 (i.e., external storage (flash)) and an antenna 20. Two antenna assignments can be applied to the wireless system package 100. (A) No built-in antenna is assigned to the wireless system package 100. The antenna 20 is regarded as an external antenna and is coupled to the wireless system package by using a RF pin of the wireless system package 100. (B) Built-in antenna is assigned to the wireless system package 100. Specifically, the wireless system package 100 has the RF pin for inspecting radio frequency (RF) signal. The first oscillator 14 is used for generating a first clock (i.e., for example, 32 MHz). The Bluetooth module 13 is coupled to the first oscillator 14 for processing a Bluetooth signal according to the first clock. As known, a clock signal provided from external is processed by a clock unit on the integrated circuit (IC). For example, signal dividing process, signal phase-locked loop (PLL) process, signal frequency multiplier process. After the clock signal is processed, the processed clock signal can be used to each components of IC. In the embodiment, the first oscillator 14 generates a first clock. The first clock is further processed by a clock unit on the integrated circuit (i.e., IC1). Then, the processed first clock can be used to the components of integrated circuit IC1 so that the processor 12, Bluetooth unit 13, internal volatile memory 18, internal non-volatile memory 19 can be operated according to a timing sequence of the first clock. The second oscillator 16 is used for generating a second clock (i.e., for example, 26 MHz). In the embodiment, the first oscillator 14 and the second oscillator 16 are internal individually. However, the present invention is not limited by the internal oscillators. For example, the first oscillator 14 and the second oscillator 16 in other embodiment are built-in components on the SOC unit 22 of an IC1 (integrated circuit) and an IC2, respectively. The Wi-Fi module 15 is coupled to the second oscillator 16 for processing a Wi-Fi signal according to the second clock. The antenna 20 is coupled to the Bluetooth module 13 and the Wi-Fi module 15 for transmitting and receiving a RF signal (wireless signal) through the RF switch 10. The processor 12 is coupled to the Bluetooth module 13 and the Wi-Fi module 15 for controlling the Bluetooth module 13 and the Wi-Fi module 15. The Balun 11 is coupled to the RF switch 10 for performing a transformation between a balanced signal and an unbalanced signal. The external non-volatile memory 17 is coupled to the processor 12 for providing an external memory capacity through bus, for example, SPI (Serial Peripheral Interface Bus). In the wireless system package 100, the RF switch 10 is coupled to the antenna 20 for controlling the time intervals of transmission between the Wi-Fi signal and the Bluetooth signal. For example, the RF switch 10 may use a time-division duplexing (TDD) method to alternatively access the Wi-Fi signal and the Bluetooth signal. The processor 12 can be any types of programmable logical unit, such as Cortex-M0 typed micro-control unit, logical chip, or central processing unit (CPU). Particularly, the CPU can execute programming, that can perform reallocated hardware (i.e., re-programmable), such as FPGA. The processor 12 is incorporated on SoC unit 22 that includes the internal volatile memory 18 and internal non-volatile memory 19. The internal volatile memory 18 may be a static random access memory (SRAM) or dynamic random access memory (DRAM) with a first memory capacity (i.e., for example, 16 KB). The internal non-volatile memory 19 may be an internal flash memory with a second memory capacity (i.e., for example, 256 KB). The Bluetooth module 13 is manufactured according to a specific Bluetooth standard, such as Bluetooth 4.0 standard or Bluetooth LE (Low Energy). The Wi-Fi module 15 is manufactured according to a specific Wi-Fi standard such as 802.11 a/b/g/n/ac Wi-Fi protocol with TCP/IP security stack. The external non-volatile memory 17 can be a plug-in memory or an external memory with a larger memory capacity than the internal non-volatile memory 19 and the internal volatile memory 18. For example, the external non-volatile memory 17 may be a flash memory with a capacity of 1 MB for saving Wi-Fi and/or Bluetooth firmware and Real Time Operation System (RTOS). The RTOS can execute application program, for example, mbed application. Specifically, the Wi-Fi and/or Bluetooth firmware is regarded as image loading data for driving the Bluetooth module 13 and/or the Wi-Fi module 15. In the wireless system package 100, the Bluetooth module 13 and the SOC unit 22 can be integrated to an IC1 (same chip). However, the present invention is not limited by integrating the Bluetooth module 13 and the SoC unit 22 to the IC1. For example, in another embodiment, the Bluetooth module 13 and the SOC unit 22 are discrete in two separate integrated circuits.

In other words, in the wireless system package 100, two integrated circuits and two heterogeneous wireless systems (i.e., Blue tooth and Wi-Fi systems) are introduced. A first integrated circuit IC1 in FIG. 1 includes the SoC unit 22. The second integrated circuit IC2 in FIG. 1 is non-SoC. The wireless system package 100 includes two integrated circuits IC1 and IC2 in conjunction with external flash with larger capacity (the external non-volatile memory 17) and at least one mode of firmware driving data. In the embodiment, the first integrated circuit IC1 with SoC unit 22 includes the Bluetooth module 13 to perform the Bluetooth transmission function. The second integrated circuit IC2 includes the Wi-Fi module 15 to perform the Wi-Fi transmission function. However, in other embodiment, the first integrated circuit IC1 can include the Wi-Fi module to perform the Wi-Fi transmission function. The second integrated circuit IC2 can includes the Bluetooth module 13 to perform the Bluetooth transmission function. The components placement of the wireless system package 100 is illustrated below.

The first integrated circuit IC1 has 4 terminals. The second integrated circuit IC2 has 3 terminals. The RF switch 10 has 3 terminals. The Balun 11 has 2 terminals. The first oscillator 14 has a terminal. The second oscillator 16 has a terminal. The external non-volatile memory 17 has a terminal. Specifically, the first terminal of the first integrated circuit IC1 is coupled to the second terminal of the Balun 11. The second terminal of the first integrated circuit IC1 is coupled to the terminal of the first oscillator 14. The third terminal of the first integrated circuit IC1 is coupled to the terminal of the external non-volatile memory 17. The first terminal of the first integrated circuit IC1 is coupled to the first terminal of the second integrated circuit IC2. The second terminal of the second integrated circuit IC2 is coupled to the second terminal of the RF switch 10. The third terminal of the second integrated circuit IC2 is coupled to the terminal of the second oscillator 16. The third terminal of the RF switch 10 is coupled to the first terminal of the Balun 11. The fourth terminal of the RF switch 10 is coupled to the antenna 20. However, the number of terminals and the allocation of terminals in each component of the wireless system package 100 are not limits by above illustration. For example, in other embodiments, a connection between two components can be used by at least one terminal. Thus, any modification, alternation, or design around based on wireless system package 100 belongs to the disclosure of the present invention. Without loss of generality, 4 types of wireless system package 100 are introduced as below.

FIG. 1A illustrates a block diagram of a first type of wireless system package 100. As shown in FIG. 1A, 5 communication interfaces CI1 to CI5 are introduced for data transmission by using at least one terminal (or say, at least one bus link). The bus include AMBA (Advanced Microcontroller Bus Architecture), AHB (Advanced High-performance Bus), ASB (Advanced System Bus), APB (Advanced Peripheral Bus) or/and bus Bridge. For example, the third communication interface CI3 (terminal) of IC1 is connected to the second communication interface CI2 (terminal) with coexistence connection. The fourth communication interface CI4 of the SoC unit 22 is connected to a Wi-Fi and SoC communication interface pin pad (i.e., SDIO/SPI). The first communication interface CI1 of the SoC unit 22 is connected to a Bluetooth communication interface pin pad (i.e., UART). The fifth communication interface CI5 of the SoC unit 22 is connected to a SoC communication interface pin pad (GPIO). Specifically, a functional circuit FC can generate a control signal to the SoC communication interface pin pad. The system host (controller) SH can generate a corresponding control signal to the Bluetooth communication interface pin pad and the Wi-Fi and SoC communication interface pin pad. The first clock unit CU1 and the second clock unit CU2 are used for processing clock signals generated from the first oscillator 14 and the second oscillator 16 respectively. Here, the Wi-Fi communication interface and the SoC communication interface are not electrically coupled by using substrate in the wireless system package 100. Thus, data transmission between the system host (i.e., for example, a controller) SH on system printed circuit board (PCB) and the Wi-Fi unit 15 has to be processed through the SoC unit 22 of the wireless system package 100, thereby leading to lower data transmission speed (1.5˜2.5M bits/sec) on the Wi-Fi and SoC communication interface pin pad.

FIG. 1B illustrates a block diagram of a second type of wireless system package 100. As shown in FIG. 1B, the block diagram of a second type of wireless system package 100 is similar to the block diagram of a first type of wireless system package 100. In the first type of wireless system package 100 illustrated in FIG. 1A, the second communication interface CI2 (the Wi-Fi unit 15) is not directly connected to the system host SH through the Wi-Fi and SoC communication interface pin pad. Since the system host SH cannot directly transmit data to the Wi-Fi unit 15, the data transmission speed is decreased. To improve the data transmission speed, in FIG. 1B, system host SH can directly transmit data to the Wi-Fi unit 15 through the Wi-Fi and SoC communication interface pin pad since the Wi-Fi and SoC communication interface pin pad is directly coupled to the third communication interface CI3 of IC1 and the second communication interface CI2 of IC2. In other words, the Wi-Fi communication interface and the SoC communication interface are electrically coupled by using substrate in the wireless system package 100. The Wi-Fi and SoC communication interface pin pad are electrically coupled to both Wi-Fi communication interface and the SoC communication interface. Thus, the system host SH on system PCB can directly transmit data to the Wi-Fi unit 15 through the Wi-Fi and SoC communication interface pin pad bypassing the SoC unit 22, thereby leading to high data transmission speed (15-25M bits/sec) on the Wi-Fi and SoC communication interface pin pad.

FIG. 1C illustrates a block diagram of a third type of wireless system package 100. As shown in FIG. 1C, two ICs IC1 and IC2 are introduced in the wireless system package 100. Here, IC1 includes a SoC unit 22. IC2 includes both Wi-Fi unit 15 and Bluetooth unit 13. Specifically, a first communication interface CI1 of IC2 corresponds to the Bluetooth unit 13. The second communication interface CI2 of IC2 corresponds to the Wi-Fi unit 15. A third communication interface CI3, a fourth communication interface CI4, and a fifth communication interface CI5 are located on the SoC unit 22. Several pin pads are also introduced in FIG. 1C. The SoC communication interface pin pad (i.e., GIPO) is coupled to the fifth communication interface CI5. A SoC communication interface pin pad-1 with first type (i.e., SDIO/SPI) is coupled to the third communication interface CI3. The SoC communication interface pin pad-2 with second type (i.e., UART) is coupled to the fourth communication interface CI4. A Bluetooth communication interface pin pad (i.e., URAT) is coupled to the first communication interface CI1. A Wi-Fi communication interface pin pad (i.e., SDIO/SPI) is coupled to the second communication interface CI2. Specifically, the SoC communication interface pin pad-1 with first type (i.e., SDIO/SPI) is electrically coupled to the Wi-Fi communication interface pin pad through a system PCB outer from the wireless system package 100. The SoC communication interface pin pad-2 with second type (i.e., UART) is electrically coupled to the Bluetooth communication interface pin pad through the system PCB outer from the wireless system package 100. By doing so, similar to the second type of wireless system package 100, the system host SH on system PCB can directly transmit data to the Wi-Fi unit 15 or the Bluetooth unit 13 without passing through the SoC unit 22, thereby leading to high data transmission speed (15-25M bits/sec) on the Wi-Fi communication interface pin pad.

FIG. 1D illustrates a block diagram of a fourth type of wireless system package 100. As shown in FIG. 1D, two ICs IC1 and IC2 are introduced in the wireless system package 100. Here, IC1 includes a SoC unit 22. IC2 includes both Wi-Fi unit 15 and Bluetooth unit 13. Specifically, a first communication interface CI1 of IC2 corresponds to the Bluetooth unit 13. The second communication interface CI2 of IC2 corresponds to the Wi-Fi unit 15. A third communication interface CI3, a fourth communication interface CI4, and a fifth communication interface CI5 are located on the SoC unit 22. Several pin pads are also introduced in FIG. 1D. A SoC communication interface pin pad (i.e., GIPO) is coupled to the fifth communication interface CI5. A Bluetooth and SoC communication interface pin pad is electrically coupled to the fourth communication interface CI4 and the first communication interface CI1 by using the substrate in the wireless system package 100. The Wi-Fi and SoC communication interface pin pad is coupled to the second communication interface CI2 and the third communication interface CI3 by using the substrate in the wireless system package 100. By doing so, the system host SH on system PCB can directly transmit data to the Wi-Fi unit 15 or the Bluetooth unit 13 bypassing the SoC unit 22, thereby leading to high data transmission speed (15-25M bits/sec) on the Wi-Fi and SoC communication interface pin pad.

The advantage of the performance improvement in wireless system package 100 is described below. First, when the wireless system package 100 is operated, the external non-volatile memory 17 can be selectivity disabled (i.e., regarded as an optional step). The wireless system package 100 can choose minimum requirement memory access to the internal volatile memory 18 with small capacity, leading to reduce power consumption. Second, a plurality of firmware driving data is saved in the external non-volatile memory 17. Thus, the internal non-volatile memory with small capacity can achieve multi-mode operation for wireless system package 100 by accessing/loading/activating/selecting the plurality of firmware driving data saving in the external non-volatile memory. Third, each integrated circuit of the first integrated circuit IC1 and the second integrated circuit IC2 has at least one communication interface with respect to corresponding pin of communication interface for accessing data to other devices.

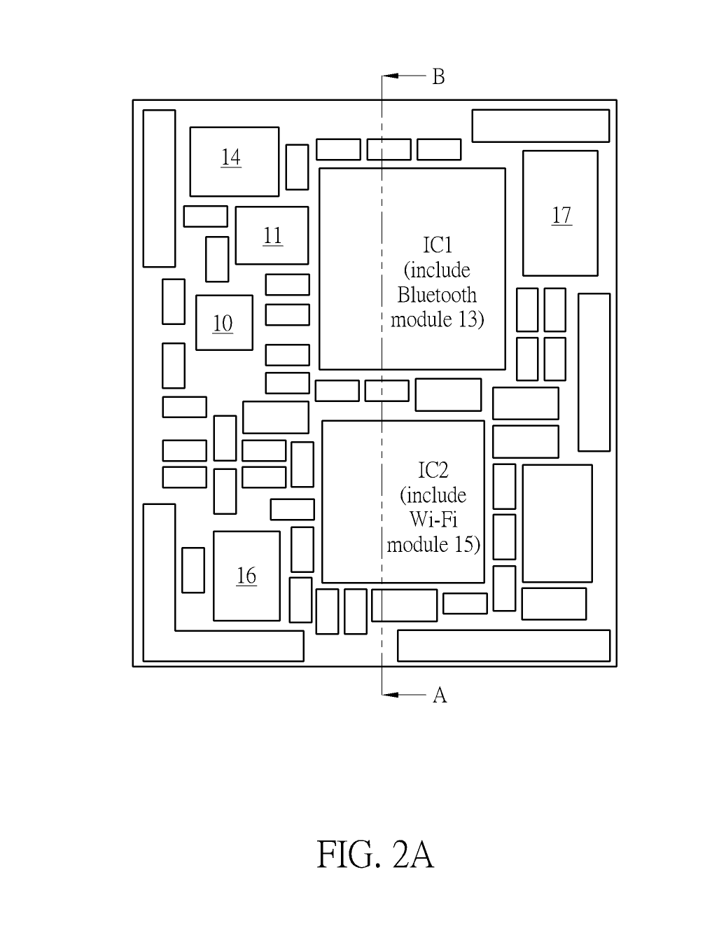

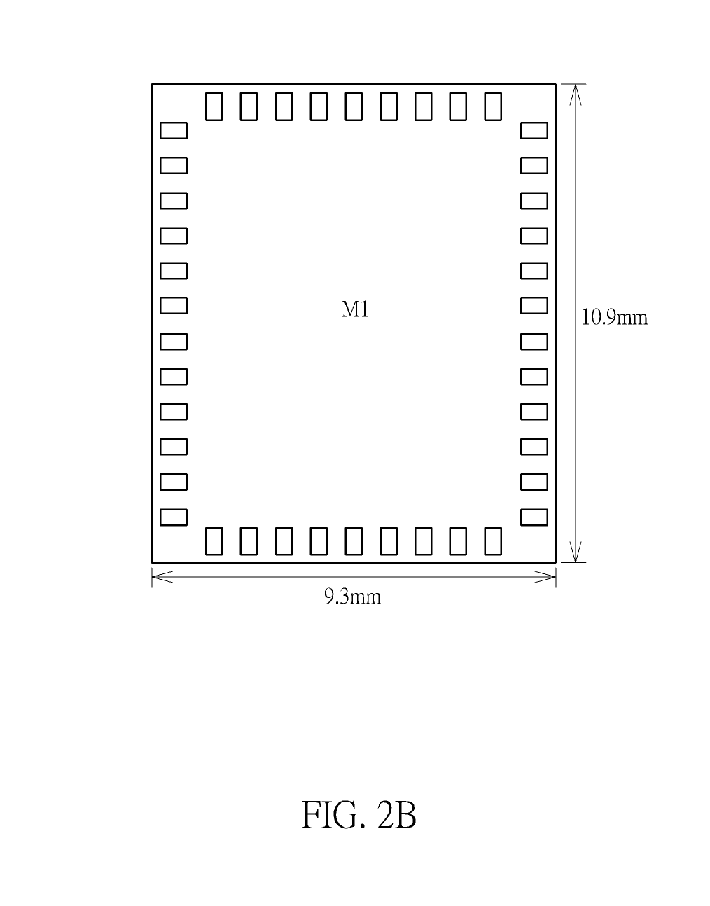

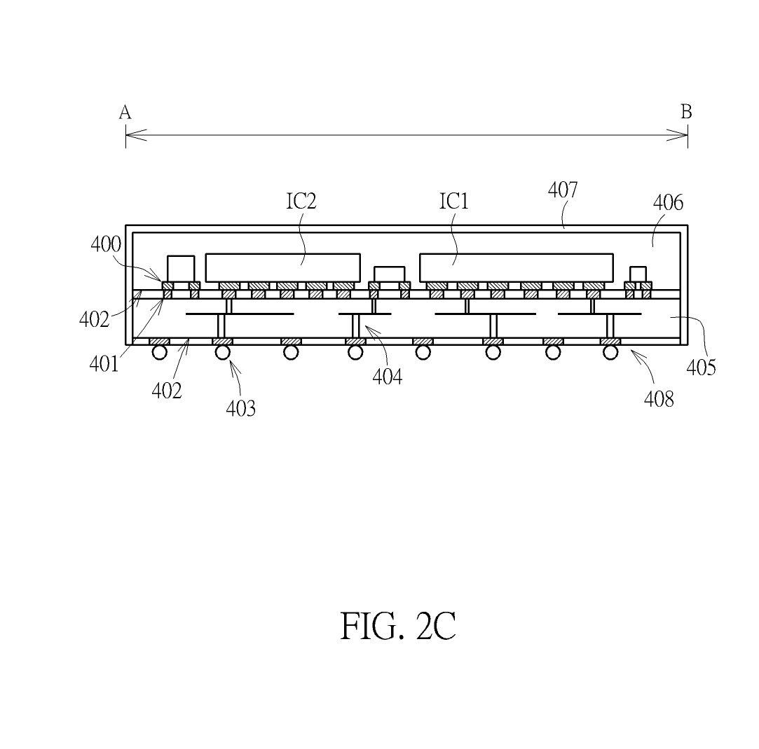

FIG. 2A illustrates a front view of components placement of the wireless system package 100. FIG. 2B illustrates an bottom view of pin pad of the wireless system package 100. FIG. 2C illustrates a cross-sectional view of the structure of the wireless system package 100. As shown in FIG. 2A, the placement of several essential components of the wireless system package 100 are described, including an RF switch 10, a Balun 11, an IC1 with integrated a Bluetooth module 13 and SOC unit 22, a first oscillator 14, an IC2 with integrated a Wi-Fi module 15, a second oscillator 16, and an external non-volatile memory 17. As shown in FIG. 2B, the wireless system package 100 is manufactured by a rectangular land grid array (LGA) substrate with 10.9 mm (Length)×9.3 mm (Width)×1.3 mm (Height). Particularly, 12 pins and 9 pins are respectively located on each length and each width of the LGA. Thus, 42 pins of LGA substrate can be used to realize the wireless system package 100 for input/output (I/O) operations. In FIG. 2C, a cross-sectional surface from point A to point B of the structure of the wireless system package 100 is illustrated (corresponding to FIG. 2A). Specifically, the structure of solder 400, pad 401, solder mask 402, solder balling 403, via 404, substrate 405, molding compound 406, EM shielding 407, and pad (pin) 408 are introduced. These components form a structure of the wireless system package 100. Specifically, components of wireless system package 100 are located on the top surface of substrate 405 and terminals of the components are coupled to contact pads 401 of the top of the substrate 405 by using solder 400. The electrical coupling (traces) of pair-wised components, several pin pads 408 and several contact pads 401 on the substrate 405 are realized via layouts from surface level and inner level of the substrate 405. The layouts further includes plurality of vias 404 (holes) in the substrate 405. The different level layouts of the substrate 405 are electrically connected to each other through vias 404. In general application, the pin pads 408 of the wireless system package 100 on the bottom surface of the substrate 405 can be mounted on the system PCB by the solder balling 403 located on the pin pads 408 (not shown). The molding compound 406 covers components on the top surface of the substrate 405 and partial top level layout of the substrate 405. The EM shielding 407 is disposed on outer surface of the molding compound 406 and lateral surface of the substrate 405 wherein the EM shielding 407 is electrically connected to ground pad or ground layout on the substrate 405 (not shown). Further, the molding compound 406 of the wireless system package 100 can be manufactured without covering the EM shielding 407. Another modification can be implemented in the other embodiment that the wireless system package 100 is manufactured without using molding compound 406. In other words, only a metal lid is used for covering all the components on the substrate 405.

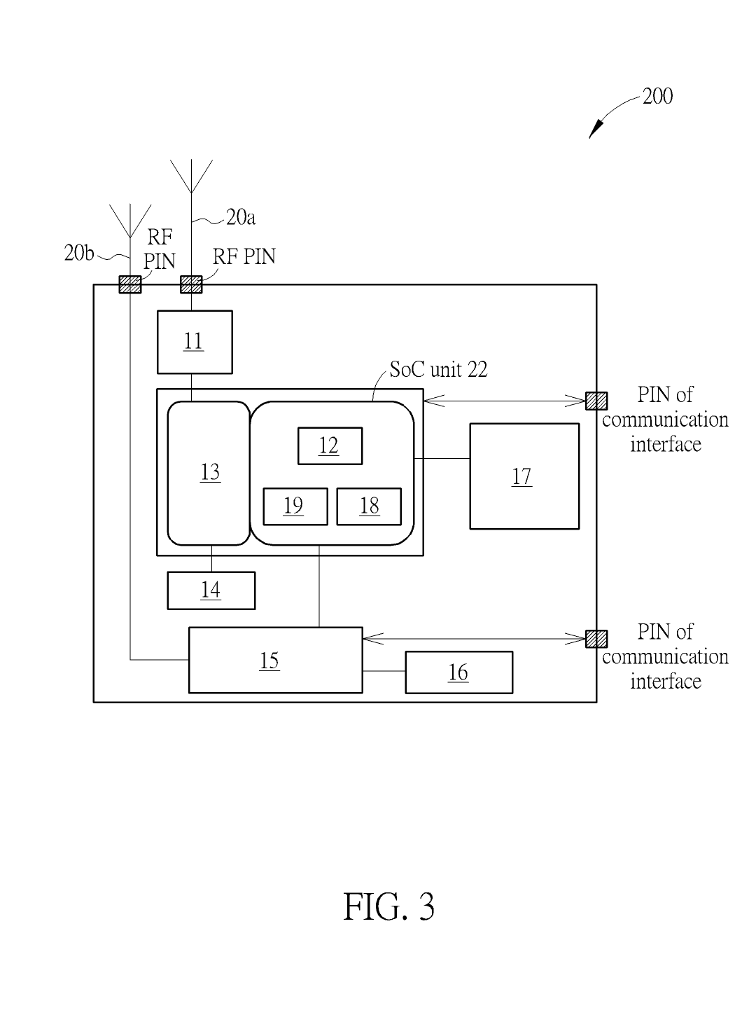

FIG. 3 is a schematic block diagram of a wireless system package 200 according to an embodiment of the present invention. As shown in FIG. 3, a structure of the wireless system package 200 is similar to the wireless system package 100. The difference between the wireless system package 200 and the wireless system package 100 is that the wireless system package 200 does not have the RF switch 10, it has two antennas 20a and 20b instead. In wireless system package 200, the antenna 20a is coupled to a Bluetooth module 13 through a Balun 11. The antenna 20b is coupled to a Wi-Fi module 15. Thus, a Wi-Fi signal can be accessed by the antenna 20b. The Bluetooth signal can be accessed by the antenna 20a. Since the Wi-Fi signal and the Bluetooth signal can be transmitted separately, the interference over TDD transmission can be minimized. Specifically, the Wi-Fi module 15 and the Bluetooth module 13 are operated according to a Wi-Fi and Bluetooth (wireless) coexistence protocol. For example, a programming of the SOC unit 22 can control the Wi-Fi module 15 and the Bluetooth module 13 by using different frequency bands. Further, the programming of the SOC unit 22 controls the operation of the RF switch 10 that the Wi-Fi signal and the Bluetooth signal can be accessed in interleaved time slots. Thus, the interference between Wi-Fi signal and the Bluetooth signal are mitigated. In the following, the network structure with respect to the wireless system package 100 or 200 is illustrated.

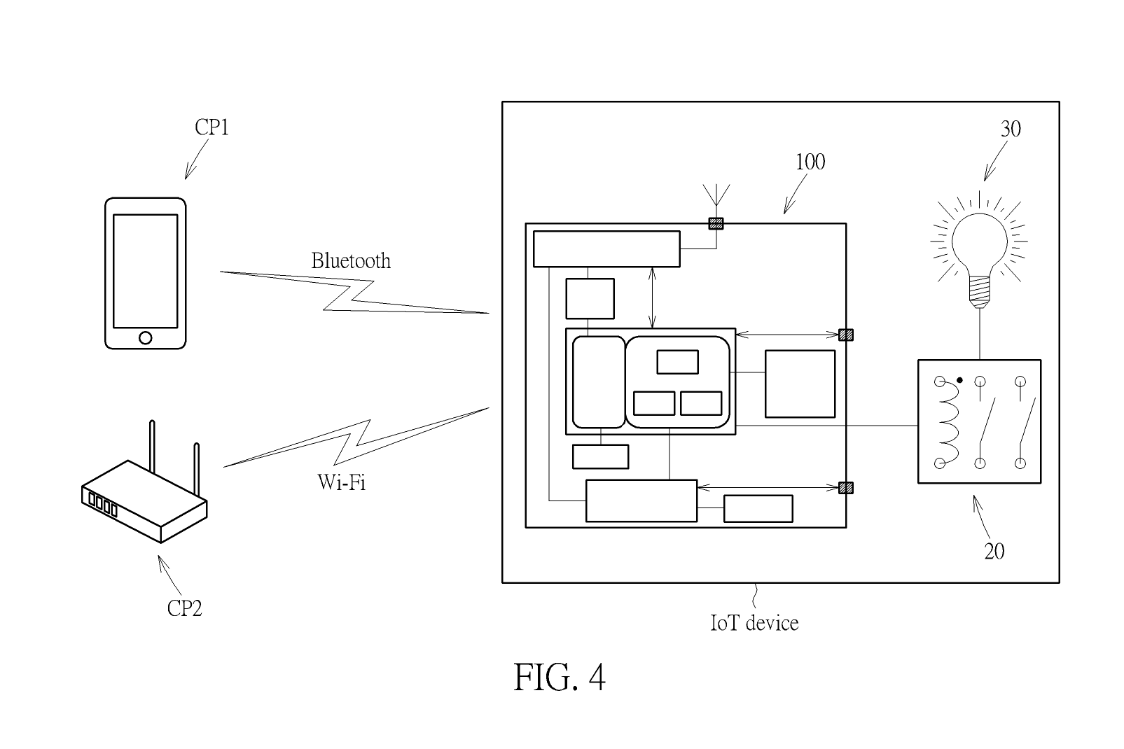

FIG. 4 illustrates a network structure according to an embodiment of the present invention. As shown in FIG. 4, the network structure is considered as an internet of things (IoT) network with two heterogeneous wireless signals. Here, two heterogeneous wireless signals can be defined as a Wi-Fi signal and a Bluetooth signal. In FIG. 4, a first connection terminal CP1 is linked to the (IOT) communication device with the wireless system package 100. The second connection terminal CP2 is linked to the communication device with wireless system package 100. An electric device 30 is also linked to the communication device with the wireless system package 100 through a relay 20 (functional circuit). Particularly, the communication device with wireless system package 100 (including several communication modules) can be combined with several functional components of the functional circuit to form an IoT device. For example, the IoT device can be a smart plug, a sensor node, smart meter or a smart lamp. The functional components can be a switch in conjunction with a socket, a gas sensor, a temperature sensor, or a pressure sensor, even a relay node of the lamp.

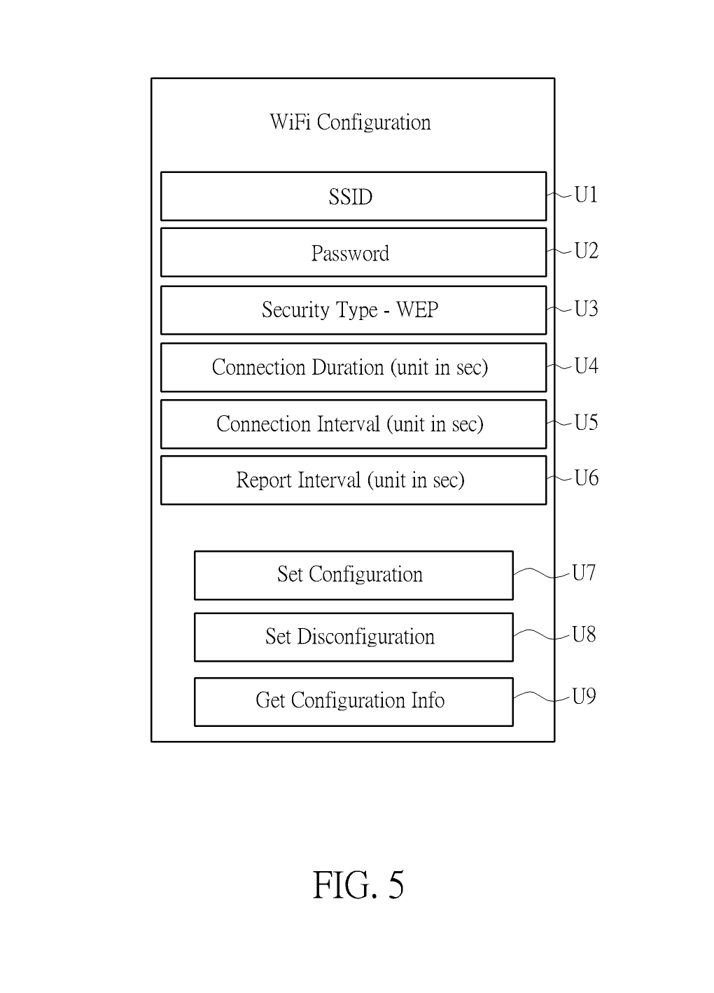

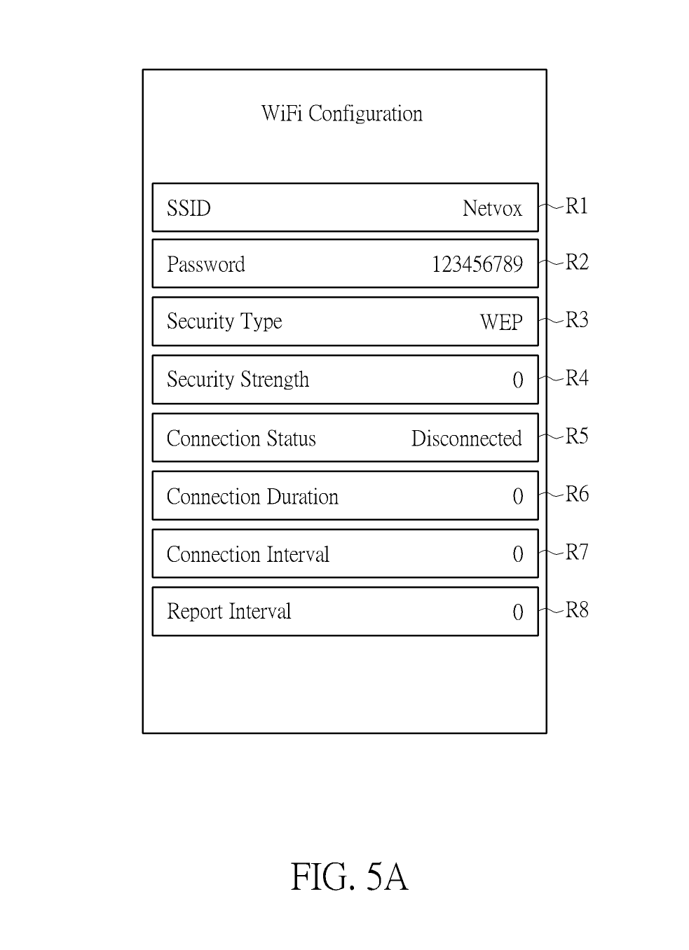

In the embodiment, the first connection terminal CP1 can be a smart phone, tablet or notebook. The second connection terminal CP2 can be a wireless access point (i.e., for example, a Wi-Fi AP). The electric device 30 can be a lamp. Specifically, before the wireless system package 100 is connected to internet, the electric device 30 is required to be configured to the available surrounding second connection terminal CP2 (Wi-Fi AP) or hot spot. In the embodiment, the idea is to set up a Wi-Fi configuration of communication device with the wireless system package 100 via a Bluetooth signal with updated Wi-Fi configuration. Since the wireless system package 100 of the communication device receives the updated Wi-Fi configuration from the first connection terminal CP1 (i.e., for example, a smart phone) through the Bluetooth signal, the wireless system package 100 can establish a connection link (Wi-Fi link) to the second connection terminal CP2 through the wireless system package 100 according to the updated Wi-Fi configuration received from the first connection terminal CP1. By doing so, the power consumption of the process for setting up the Wi-Fi configuration can be reduced. In practice, the first connection terminal CP1 has an application program (APP) and a corresponding user interface. The Wi-Fi configuration data including connection information (IP address), SSID information, Wi-Fi security key and security type can be inputted by using the user interface. FIG. 5 illustrates the user interface of application program of the first communication terminal CP1 according to the embodiment of the present invention. As shown in FIG. 5, the user interface of the first communication terminal CP1 includes a window of service set identifier (SSID) U1, a window of password (Wi-Fi security key) U2, a window of security type U3, a window of connection duration U4, a window of connection interval U5, a window of report interval U6, a window of set connection U7, a window of set disconnection U8, and a window of get configuration information U9. In FIG. 5, several parameters can be adjusted for Wi-Fi configuration to set up an advanced Wi-Fi connection.

FIG. 5A illustrates an interface with configuration acquirement according to an embodiment of the present invention. Here, the configuration denotes the Wi-Fi configuration parameters (i.e., it can be shown as an original Wi-Fi configuration or an updated Wi-Fi configuration) of a Wi-Fi link between the second connection terminal CP2 and the wireless system package 100. In the embodiment, the interface with configuration acquirement can be displayed on the first connection terminal CP1 (smart phone) or the wireless system package 100. As shown in FIG. 5A, the interface with configuration acquirement includes a window R1 for displaying SSID status, a window R2 for displaying password, a window R3 for displaying security type, a window R4 for displaying signal strength, a window R5 for displaying connection status, a window R6 for displaying connection duration, a window R7 for displaying connection interval, and a window R8 for displaying report interval. Specifically, the report interval denotes as a time interval for reporting Wi-Fi connection data. The connection interval denotes as an available Wi-Fi connection period. When the Wi-Fi is connected over the connection interval, the Wi-Fi link will be disconnected. The connection duration denotes as a retry period. In other words, the connection duration denotes that when the Wi-Fi connection is interrupted or disconnected, the timing period for re-establishing Wi-Fi connection automatically.

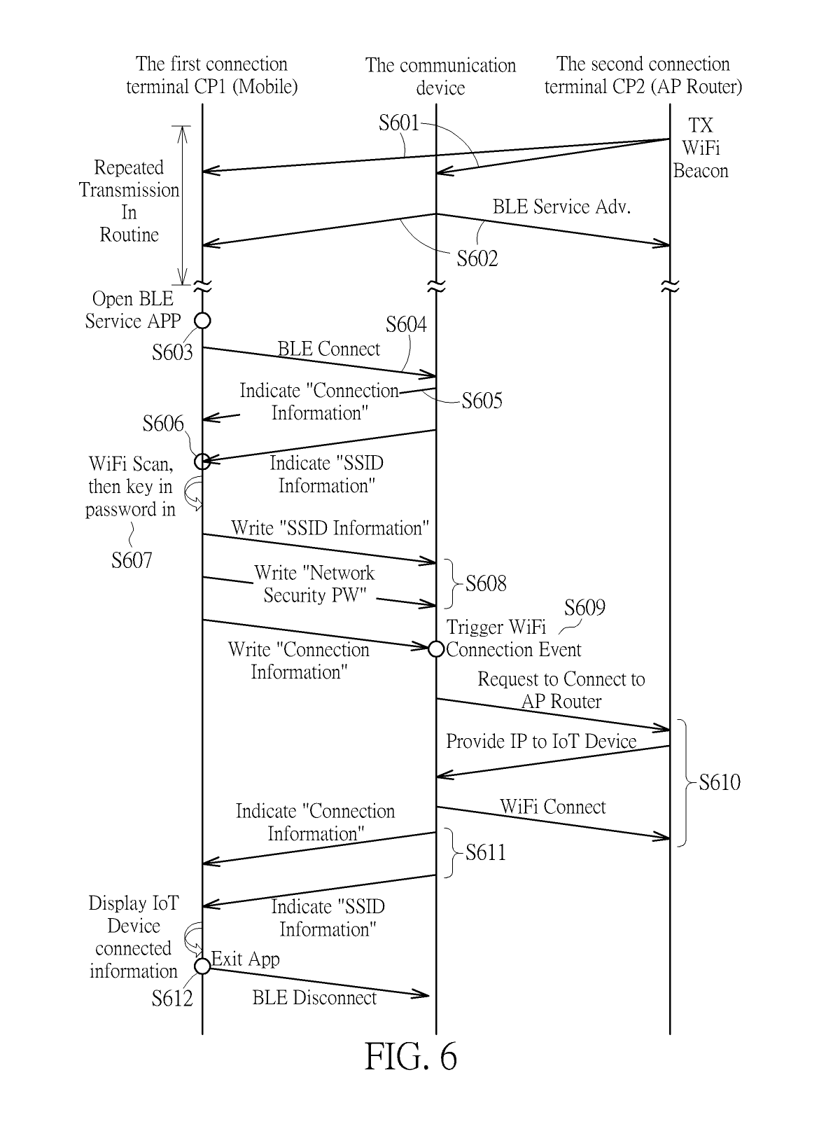

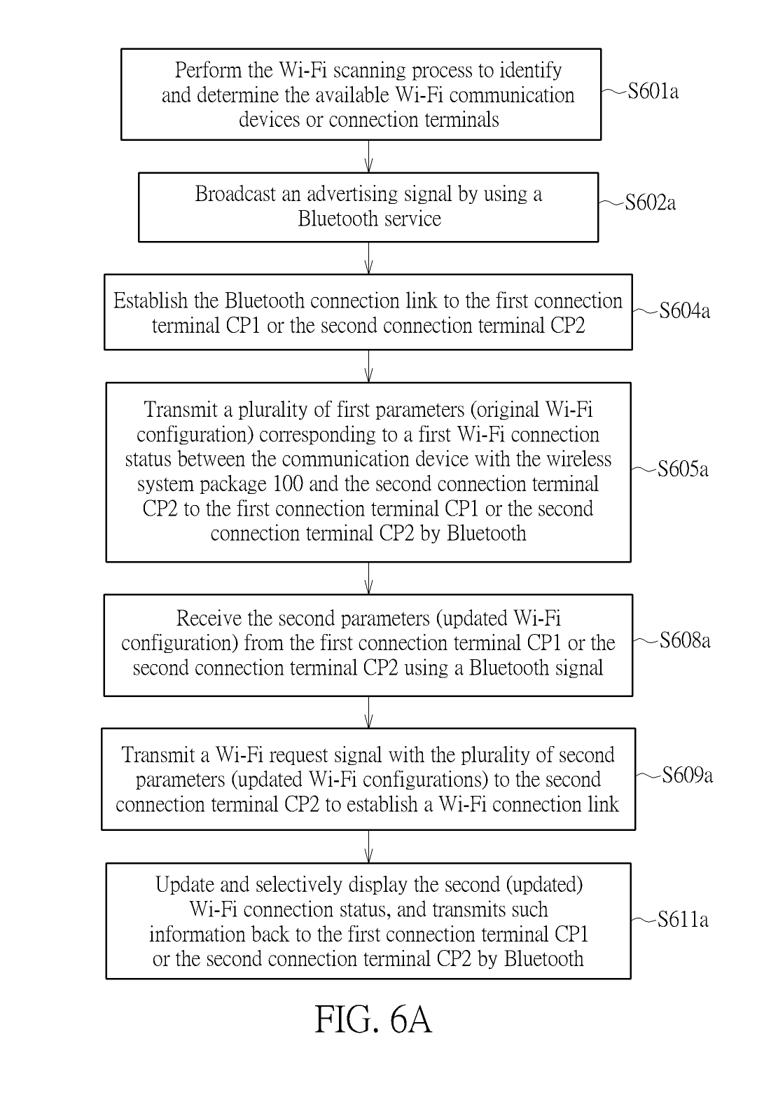

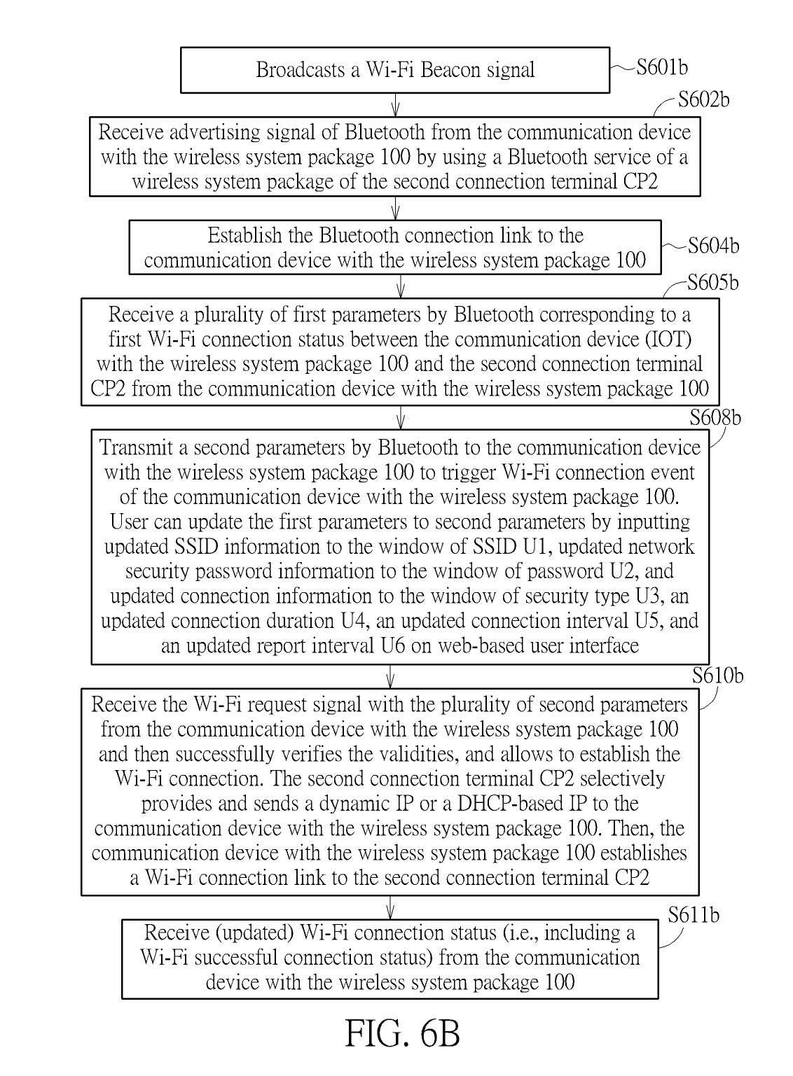

FIG. 6 illustrates a communication method for configuring Wi-Fi service between the communication device with the wireless system package 100 and two communication terminals CP1 and CP2 according to the embodiment of the present invention. As shown in FIG. 6, the second communication terminal CP2 (WI-FI AP Router) broadcasts a Wi-Fi Beacon signal in step S601. Then, the communication device with the wireless system package 100 (Bluetooth module 13) broadcasts an advertising signal by using Bluetooth service in step S602. Here, the advertising signal is used for informing the surrounding Wi-Fi AP routers (i.e., the second communication terminal CP2) or mobiles (i.e., the first communication terminal CP1) that the communication device with the wireless system package 100 is available and is currently active. The above acknowledge pre-linked process may be repeated in routine until the connection link is established. A Bluetooth service application program on the first communication terminal CP1 (or the second communication terminal CP2) is performed in step S603. After the Bluetooth service application program is activated, the first communication terminal CP1 establishes a Bluetooth connection link to the communication device with the wireless system package 100. After the Bluetooth connection link is established in step S604, the communication device with the wireless system package 100 transmits a plurality of first parameters by Bluetooth corresponding to a first Wi-Fi connection status between the communication device with the wireless system package 100 and the second connection terminal CP2 to a first connection terminal CP1 in step S605. Here, the plurality of first parameters denote some default parameters, old parameters, or initial parameters of an original Wi-Fi status. For example, the plurality of first parameters can indicate Wi-Fi connection configuration information (i.e., for example, priority level, signal intensity value, security encoding type), internet protocol (IP) address, a network security password, and SSID information. Then, the user can acquire the plurality of first parameters from the user interface on the first communication terminal CP1 in step S606. For example, an interface with configuration acquirement (or say, get configuration interface) illustrated in FIG. 5A can be shown to a user for displaying current parameters setting of the communication device with the wireless system package 100. If the user intends to change the Wi-Fi configurations, the user can update the first parameters to second parameters by inputting updated SSID information to the window of SSID U1, updated network security password information to the window of password U2, and updated connection information to the window of security type U3, an updated connection duration U4, an updated connection interval U5, and an updated report interval U6 in step S607. The first connection terminal CP1 transmits the second parameters by Bluetooth to the communication device with the wireless system package 100 in step S608. The communication device with the wireless system package 100 receives the plurality of the second parameters corresponding to the second Wi-Fi connection status from the first connection terminal CP1. Specifically, the above transmission (i.e., establishing a Wi-Fi link) between the communication device with the wireless system package 100 and the first connection terminal CP1 is performed by using a Bluetooth signal with the second parameters (updated Wi-Fi configuration). After the communication device with the wireless system package 100 receives the plurality of second parameters (i.e., updated Wi-Fi configurations), the Wi-Fi connection event is triggered in step S609. Initially, the communication device with the wireless system package 100 transmits a Wi-Fi request signal with the plurality of second parameters (updated Wi-Fi configurations) to the second connection terminal CP2. After the second connection terminal CP2 receives the Wi-Fi request signal with the plurality of second parameters and then successfully verifies the validities, the second terminal CP2 allows establishing the Wi-Fi connection link. Then, the second connection terminal CP2 selectively provides and sends a dynamic IP or a DHCP-based IP to the communication device with the wireless system package 100 in step S610. In other embodiments, the IP of communication device with the wireless system package 100 can be assigned by user (i.e., user-defined IP). Then, the communication device with the wireless system package 100 establishes a Wi-Fi connection link to the second connection terminal CP2 according to the plurality of second parameters corresponding to the second Wi-Fi connection status.

Here, the second Wi-Fi connection status is regarded as the user-defined or user-upgraded Wi-Fi connection status. The communication device with the wireless system package 100 updates and displays (i.e., for example, communication device with LCD can be used for displaying configuration parameters) the second (updated) Wi-Fi connection status in step S611. After the communication device with the wireless system package 100 successfully establishes the connection link to the second connection terminal CP2 according to the plurality of second parameters, the communication device with the wireless system package 100 transmits the plurality of second parameters back to the first connection terminal CP1, including the transmission of the updated connection information, a connection successful status, and the updated SSID information. Finally, the application program is exited or logged out by the user in the first connection terminal CP1 in step S612.

In FIG. 6, since the Wi-Fi configuration of the communication device with the wireless system package 100 can be updated, changed, or adjusted by the first connection terminal CP1 through the Bluetooth service signal, the power consumption for configuring wireless network of the communication device with the wireless system package 100 can be reduced, while the Bluetooth link establishment is also simpler than Wi-Fi. In the embodiment, the Wi-Fi scanning process is achieved by receiving Wi-Fi Beacon signal in step S601 for identifying the available communication devices to be established Wi-Fi link, and determining the communication devices if located within the Wi-Fi coverage. The idea of Bluetooth scanning process is also similar to the Wi-Fi scanning process. The collection of the Wi-Fi Beacon signals can be executed by communication device with the wireless system package 100 or the first connection terminal CP1. By doing so, the configuring Wi-Fi service on the communication device with the wireless system package 100 can identify the Wi-Fi device to be established Wi-Fi link. Accordingly, the user input (i.e., key-in information) and a corresponding Wi-Fi password (or the corresponding Wi-Fi password automatically provided by the program) are transmitted to the communication device with the wireless system package 100. Then, the communication device with the wireless system package 100 establishes the Wi-Fi link accordingly. Specifically, the Wi-Fi Beacon signal in step S601 and the advertising signal is step S602 are broadcasted continuously. Thus, the Bluetooth link in step S604 and the Wi-Fi link establishment in step S610 can be performed accordingly.

For presentation simplicity, the flow chart of the communication process of the communication device with the wireless system package 100 (i.e., IoT) is shown in FIG. 6A. Further, the flow chart of the communication process of the second connection terminal CP2 (i.e., Wi-Fi AP router) is shown in FIG. 6B, as illustrated below. Consider the communication process between the first connection terminal CP1 (i.e., mobile) and the communication device 100. As shown in FIG. 6A, the process can be the configuring Wi-Fi service executed on the processor 12, which includes the following steps:

Step S601a: Perform the Wi-Fi scanning process to identify and determine the available Wi-Fi communication devices or connection terminals;

Step S602a: Broadcast an advertising signal by using a Bluetooth service;

Step S604a: Establish the Bluetooth connection link to the first connection terminal CP1 or the second connection terminal CP2;

Step S605a: Transmit a plurality of first parameters (original Wi-Fi configuration) corresponding to a first Wi-Fi connection status between the communication device with the wireless system package 100 and the second connection terminal CP2 to the first connection terminal CP1 or the second connection terminal CP2 by Bluetooth;

Step S608a: Receive the second parameters (updated Wi-Fi configuration) from the first connection terminal CP1 or the second connection terminal CP2 using a Bluetooth signal;

Step S609a: Transmit a Wi-Fi request signal with the plurality of second parameters (updated Wi-Fi configurations) to the second connection terminal CP2 to establish a Wi-Fi connection link;

Step S611a: Update and selectively display the second (updated) Wi-Fi connection status, and transmits such information back to the first connection terminal CP1 or the second connection terminal CP2 by Bluetooth.

Consider the communication process between the communication device with the wireless system package 100 and a second connection terminal CP2 (i.e., Wi-Fi AP router). As shown in FIG. 6B, the process can be performed by an application program and a corresponding web-based user interface executed on a processor 12 of the wireless system package of the second connection terminal CP2, which includes the following steps:

Step S601b: Broadcasts a Wi-Fi Beacon signal;

Step S602b: Receive advertising signal of Bluetooth from the communication device with the wireless system package 100 by using a Bluetooth service of a wireless system package of the second connection terminal CP2;

Step S604b: Establish the Bluetooth connection link to the communication device with the wireless system package 100;

Step S605b: Receive a plurality of first parameters by Bluetooth corresponding to a first Wi-Fi connection status between the communication device (IOT) with the wireless system package 100 and the second connection terminal CP2 from the communication device with the wireless system package 100;

Step S608b: Transmit a second parameters by Bluetooth to the communication device with the wireless system package 100 to trigger Wi-Fi connection event of the communication device with the wireless system package 100. User can update the first parameters to second parameters by inputting updated SSID information to the window of SSID U1, updated network security password information to the window of password U2, and updated connection information to the window of security type U3, an updated connection duration U4, an updated connection interval U5, and an updated report interval U6 on web-based user interface;

Step S610b: Receive the Wi-Fi request signal with the plurality of second parameters from the communication device with the wireless system package 100 and then successfully verifies the validities, and allows to establish the Wi-Fi connection. The second connection terminal CP2 selectively provides and sends a dynamic IP or a DHCP-based IP to the communication device with the wireless system package 100. Then, the communication device with the wireless system package 100 establishes a Wi-Fi connection link to the second connection terminal CP2;

Step S611b: Receive (updated) Wi-Fi connection status (i.e., including a Wi-Fi successful connection status) from the communication device with the wireless system package 100;

In the following, a message propagation method for facilitating the establishment of the Wi-Fi connection link over several communication devices is illustrated.

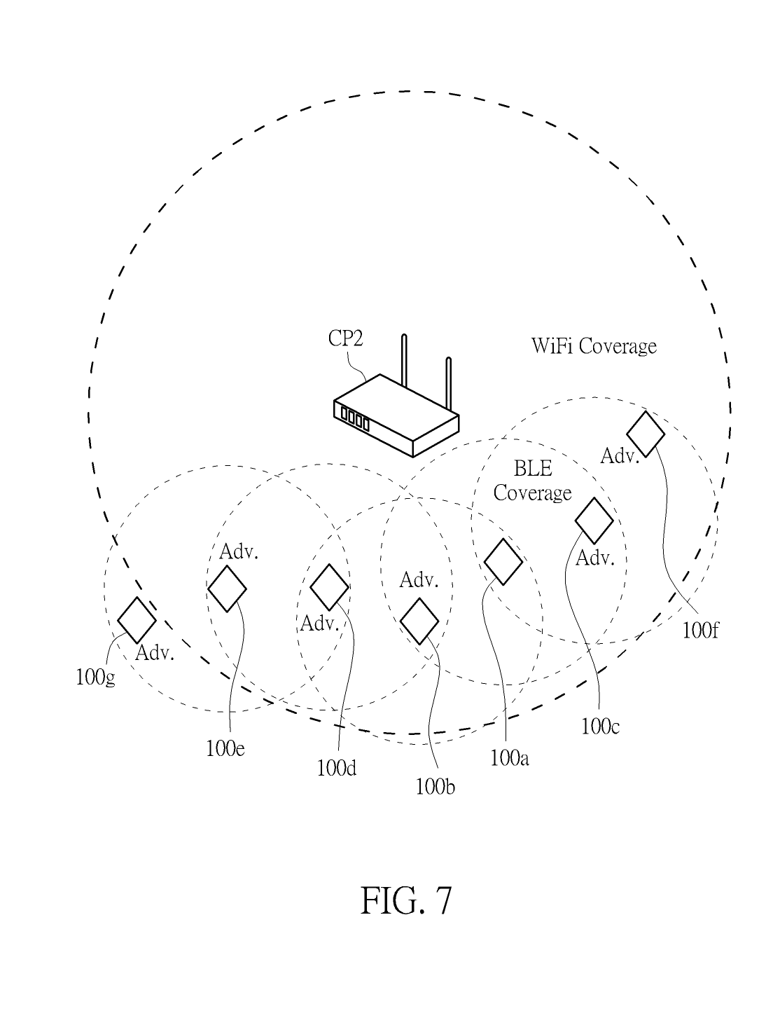

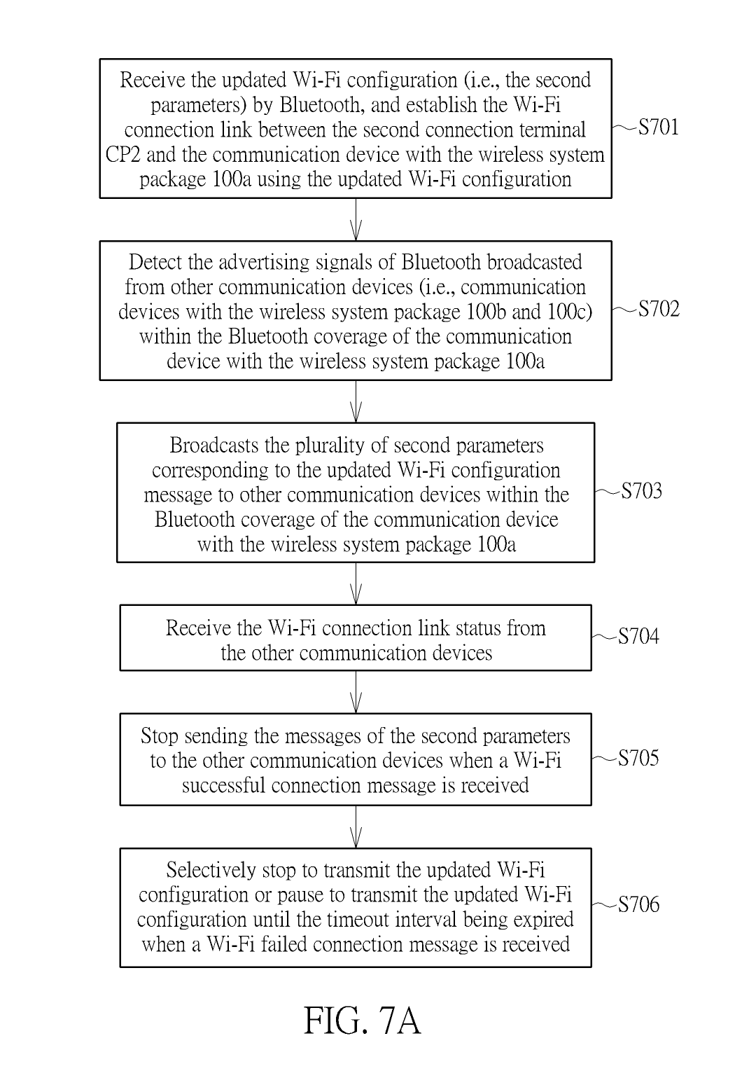

FIG. 7 illustrates a message propagation method of the communication device with the wireless system package according to an embodiment of the present invention. As shown in FIG. 7, communication devices with the wireless system package 100a to 100g are considered to establish Wi-Fi connection links. A circular with center at a second connection terminal CP2 (Wi-Fi AP) denotes a Wi-Fi transmission range (i.e., Wi-Fi coverage) of a second connection terminal CP2 (Wi-Fi AP). Several circulars with center at the wireless system package 100a to 100g denote Bluetooth transmission ranges (i.e., Bluetooth (BLE) coverage) corresponding to each communication device with the wireless system package 100a to 100g. Initially, it is assumed that the updated Wi-Fi configuration (i.e., the second parameters) has already been applied on the communication device with the wireless system package 100a for establishing the Wi-Fi connection link. Then, the communication device with the wireless system package 100a starts to detect the advertising signals of Bluetooth broadcasted from other communication devices (i.e., communication devices with the wireless system package 100b and 100c) within the Bluetooth coverage of the communication device with the wireless system package 100a. After several surrounding communication devices with the wireless system package 100b and 100c are detected, the communication device with the wireless system package 100a broadcasts the plurality of the second parameters corresponding to the updated Wi-Fi configuration message by Bluetooth. Particularly, the communication device with the wireless system package 100a can broadcasts data directly to the communication devices with the wireless system package 100b and 100c. However, it lacks of transmission security, while the data transmission is also limited. A preferred embodiment is that the communication device with the wireless system package 100a establishes a Bluetooth connection link to the communication devices with the wireless system package 100b or 100c by using step S604 and further performs data transmission process through step S605 to S612. After the communication devices with the wireless system package 100b and 100c receive the messages of the second parameters by Bluetooth, the communication devices with the wireless system package 100b and 100c try to establish a Wi-Fi connection link to the second connection terminal CP2 using the updated Wi-Fi configuration. Specifically, when the communication devices with the wireless system package 100b and 100c are located within the Wi-Fi coverage of the second connection terminal CP2 and the Bluetooth coverage of the communication devices with the wireless system package 100a, the communication devices with the wireless system package 100b and 100c can successfully establish the Wi-Fi connection link to the second connection terminal CP2 according to the updated Wi-Fi configuration provided from the communication device with the wireless system package 100a by Bluetooth. When the communication devices with the wireless system package 100b and 100c establish the Wi-Fi connection link successfully and the successful link message is transmitted back to the communication devices with the wireless system package 100a, the communication device with the wireless system package 100a stops sending the messages of the second parameters to the communication devices with the wireless system package 100b and 100c by Bluetooth. Similarly, when the communication device with the wireless system package 100f is located within the Wi-Fi coverage of the second connection terminal CP2 and Bluetooth coverage of the communication device with the wireless system package 100c and receives the message of the second parameters from the communication device with the wireless system package 100c by Bluetooth, the communication device with the wireless system package 100f can successfully establish the Wi-Fi connection link to the second connection terminal CP2 according to the updated Wi-Fi configuration provided from the communication device with the wireless system package 100c by Bluetooth. When the communication device with the wireless system package 100d is located within the Wi-Fi coverage of the second connection terminal CP2 and the Bluetooth coverage of the communication device with the wireless system package 100b, and receives the message of the second parameters from the communication device with the wireless system package 100b by Bluetooth, the communication device with the wireless system package 100d can successfully establish the Wi-Fi connection link to the second connection terminal CP2 according to the updated Wi-Fi configuration provided from the communication device with the wireless system package 100b by Bluetooth. Finally, the messages of the second parameters are propagated from the communication device with the wireless system package 100a to 100e by Bluetooth. As a result, the communication devices with the wireless system package 100a to 100e within the Wi-Fi coverage of the second connection terminal CP2 can successfully establish Wi-Fi connection links according to the second parameters correspond to the updated Wi-Fi configuration. Without loss of generality, a communication device with the wireless system package 100g located inside the Bluetooth converge of the communication device with the wireless system package 100e but outside the Wi-Fi coverage of the second connection terminal CP2 is considered. In this case, the communication device with the wireless system package 100g broadcasts the advertising signal of Bluetooth. After receiving the advertising signal of Bluetooth from the communication device with the wireless system package 100g, the communication device with the wireless system package 100e transmits the second parameters (updated Wi-Fi configuration) to the communication device with the wireless system package 100g. As indicated above, the communication device with the wireless system package 100e can broadcasts data directly to the communication devices with the wireless system package 100g. However, it lacks of transmission security, while the data transmission is also limited. A preferred embodiment is that the communication device with the wireless system package 100e establishes a Bluetooth connection link to the communication devices with the wireless system package 100g by using step S604. Specifically, the communication device with the wireless system package 100e can readout an identity information such as device serial number or the unique Bluetooth MAC address of the communication device with the wireless system package 100g (i.e., each communication device can read out the Bluetooth MAC address from other communication device within the Bluetooth coverage). Then, the communication device with the wireless system package 100e saves the Bluetooth MAC address (identity information) of the communication device with the wireless system package 100g with a timeout interval (i.e., several minutes) if the communication device with the wireless system package 100g fails to establish a Wi-Fi connection link to the second connection terminal CP2. Here, since the communication device with the wireless system package 100g is located outside the Wi-Fi coverage of the second connection terminal CP2, the Wi-Fi connection link cannot be established. To avoid transmitting the messages of the second parameters to the communication device with the wireless system package 100g infinitely, the communication device with the wireless system package 100e may be paused to connect to the same identity information twice before the timeout interval is expired. For example, after the Bluetooth connection link is established between the communication device with the wireless system package 100e and 100g, and the updated Wi-Fi configuration is transmitted, even Wi-Fi connection establishment is failed between the communication device with the wireless system package 100g and the second connection terminal CP2, the communication device with the wireless system package 100e may be paused to connect the wireless system package 100g by using Bluetooth until the timeout interval being expired. In other words, the communication device with the wireless system package 100e may only connect (i.e., transmit the message of the second parameters by Bluetooth) to the communication device with the wireless system package 100g once during the timeout interval. Since the timeout interval can be a user-defined time duration, the communication device with the wireless system package 100g may be able to access the Wi-Fi connection link or Bluetooth connection link of the second connection terminal CP2 (i.e., mobile AP such as handset in hot-spot mode) again after the timeout interval if the communication device with the wireless system package 100g falls within the Wi-Fi transmission range (Wi-Fi coverage) of the second connection terminal CP2 later on, leading by a dynamic and flexible connection establishment.

For presentation simplicity, a flow chart of the connection process of the communication device with the wireless system package 100a in FIG. 7 is illustrated in FIG. 7A. As shown in FIG. 7A, the processes can be the configuring Wi-Fi service being executed on a processor of the communication device with the wireless system package 100a, that includes steps:

Step S701: Receive the updated Wi-Fi configuration (i.e., the second parameters) by Bluetooth, and establish the Wi-Fi connection link between the second connection terminal CP2 and the communication device with the wireless system package 100a using the updated Wi-Fi configuration;

Step S702: Detect the advertising signals of Bluetooth broadcasted from other communication devices (i.e., communication devices with the wireless system package 100b and 100c) within the Bluetooth coverage of the communication device with the wireless system package 100a;

Step S703: Broadcasts the plurality of second parameters corresponding to the updated Wi-Fi configuration message to other communication devices within the Bluetooth coverage of the communication device with the wireless system package 100a;

Step S704: Receive the Wi-Fi connection link status from the other communication devices;

Step S705: Stop sending the messages of the second parameters to the other communication devices when a Wi-Fi successful connection message is received;

Step S706: Selectively stop to transmit the updated Wi-Fi configuration or pause to transmit the updated Wi-Fi configuration until the timeout interval being expired when a Wi-Fi failed connection message is received.

Specifically, in step S703, the communication device with the wireless system package 100a can broadcasts data (updated Wi-Fi configuration message) directly to the communication devices with the wireless system package 100b and 100c. However, it lacks of transmission security, while the data transmission is also limited. A preferred embodiment is that the communication device with the wireless system package 100a establishes a Bluetooth connection link to the communication devices with the wireless system package 100b or 100c by using step S604 and further performs data transmission process through step S605 to S612. In step 704, the Wi-Fi connection link status includes a Wi-Fi successful connection message and a Wi-Fi failed connection message.

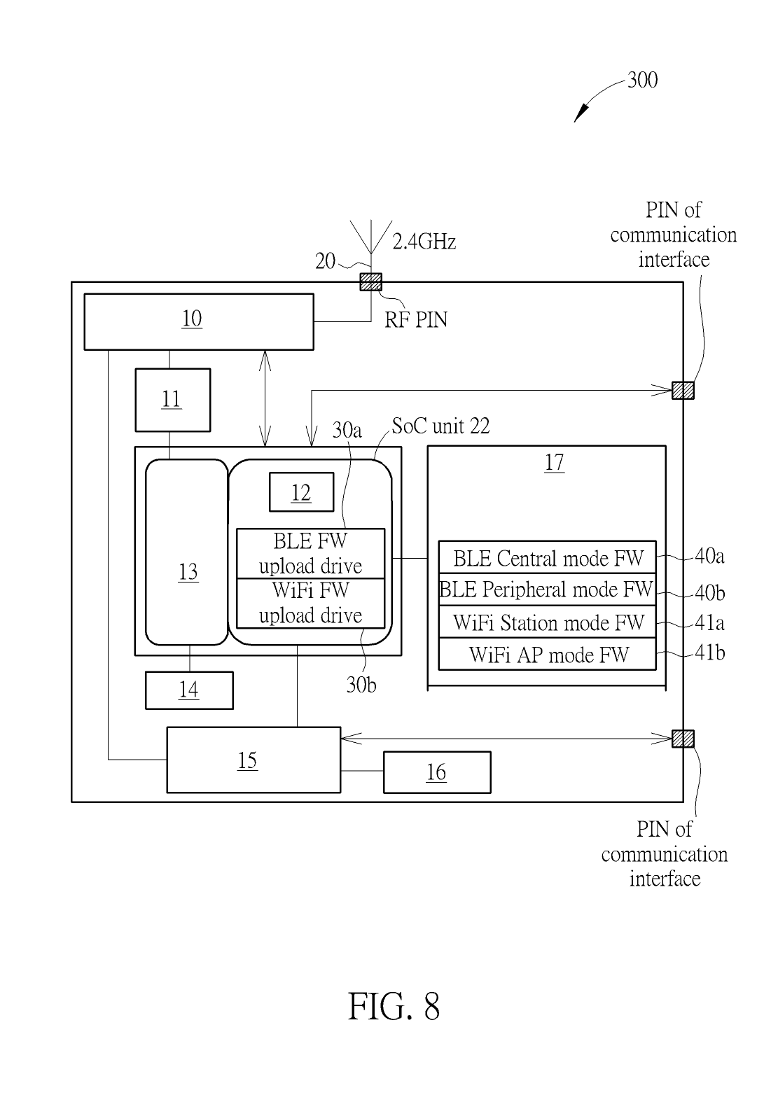

FIG. 8 illustrates a schematic block diagram of a wireless system package 300 according to an embodiment of the present invention. As shown in FIG. 8, specifically, hardware structure of the SoC unit 22 of the wireless system package 300 is identical to the hardware structure of the SoC unit 22 of the wireless system package 100 and 200. The difference is that the processor 12 of the wireless system package 300 can execute additional programming functions (multi-mode upload driver firmware). Since multi-mode upload driver firmware includes a Bluetooth module upload driver firmware 30a and a Wi-Fi module upload driver firmware 30b and selectively saved in the internal non-volatile memory 19 or the external non-volatile memory 17. Specifically, SoC unit 22 with high level processor 12 has capability of executing programming functions of external non-volatile memory 17. SoC unit 22 with low level processor 12 can only execute programming functions stored in the external non-volatile memory 17. In the embodiment, the processor 12 can perform multi-mode upload driver firmware with respect to multi-modes communication operations, as illustrated below. In the wireless system package 300, the Wi-Fi module upload driver firmware 30b provides a Wi-Fi firmware driving data to the Wi-Fi module 15 for initializing the Wi-Fi module 15. The Bluetooth module upload driver firmware 30a provides a Bluetooth firmware driving data to the Bluetooth module 13 for initializing the Bluetooth module 13. Further, the external non-volatile memory 17 includes a plurality of firmware driving data of the Wi-Fi module 15 and a plurality of firmware driving data of the Bluetooth module 13. In the embodiment, the firmware driving data of the Wi-Fi module 15 denotes the firmware with respect to several Wi-Fi operation modes. For example, Wi-Fi station mode firmware 41a and Wi-Fi AP mode firmware 41b (i.e., image file) are saved in the external non-volatile memory 17. Further, the firmware driving data of the Bluetooth module 13 denotes the firmware with respect to several Bluetooth operation modes. For example, Bluetooth central mode firmware 40a and Bluetooth peripheral mode firmware 40b (i.e., image file) are saved in the external non-volatile memory 17. Here, the Bluetooth module upload driver firmware 30a and the Wi-Fi module upload driver firmware 30b require small memory capacity (smaller than 10 KB). The Bluetooth central mode firmware 40a, the Bluetooth peripheral mode firmware 40b, the Wi-Fi station mode firmware 41a and Wi-Fi AP mode firmware 41b belong to image data so that they require large memory capacity (larger than 100 KB). In the embodiment, the processor 12 can execute the Bluetooth module upload driver firmware 30a and/or the Wi-Fi module upload driver firmware 30b to selectively load the plurality of firmware driving data of the Bluetooth module 13 and the plurality of firmware driving data of the Wi-Fi module 15 from the external non-volatile memory 17 to the Bluetooth module 13 and the Wi-Fi module 15 to initialize the Bluetooth module 13 and/or the Wi-Fi module 15 respectively. The processor 12 can electively control the Bluetooth module 13 and the Wi-Fi module 15 in several operation mode by loading the plurality of firmware driving data save in the external non-volatile memory 17 through the multi-mode upload driver firmware. As a result, the wireless system package 300 supports several operation modes of Wi-Fi and Bluetooth service. Specifically, the Bluetooth central mode firmware 40a, the Bluetooth peripheral mode firmware 40b, the Wi-Fi station mode firmware 41a, and the Wi-Fi AP mode firmware 41b cannot be loaded and saved in the internal non-volatile memory 19 at the same time since they require large memory capacity. The method for processing various operation modes of Wi-Fi and Bluetooth service in the wireless system package 300 is illustrated below.

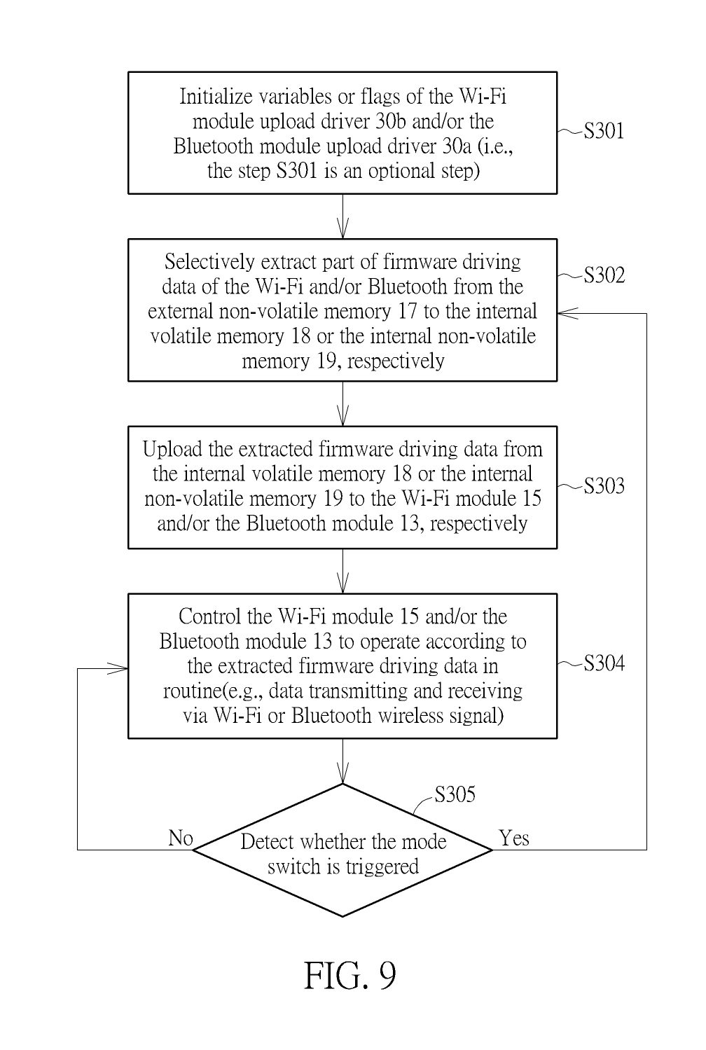

FIG. 9 illustrates a flow chart of multi-modes selection process of the wireless system package 300 according to an embodiment of the present invention. As shown in FIG. 9, the process for selecting various operation modes in the wireless system package 300 by the processor 12 includes step S301 to step S306, as illustrated below. The processes can be the multi-mode upload driver firmware being executed on the processor 12.
step S301: Initialize variables or flags of the Wi-Fi module upload driver 30b and/or the Bluetooth module upload driver 30a (i.e., the step S301 is an optional step);
step S302: Selectively extract part of firmware driving data of the Wi-Fi and/or Bluetooth from the external non-volatile memory 17 to the internal volatile memory 18 or the internal non-volatile memory 19, respectively;
step S303: Upload the extracted firmware driving data from the internal volatile memory 18 or the internal non-volatile memory 19 to the Wi-Fi module 15 and/or the Bluetooth module 13, respectively;
step S304: Control the Wi-Fi module 15 and/or the Bluetooth module 13 to operate according to the extracted firmware driving data in routine (e.g., data transmitting and receiving via Wi-Fi or Bluetooth wireless signal);
step S305: Detect whether the mode switch is triggered. If the mode switch is triggered, go to step S302; else go to step S304 or end process.

In step S301, the Wi-Fi module upload driver 30b and/or the Bluetooth module upload driver 30a is initialized. Specifically, the variables of the internal volatile memory 18, flags of the processor 12 or pin of the wireless system package 300 are initialized or set up a specific value or status, such as true or false logical hypothesis. For multi-modes communication operation of wireless system package having internal non-volatile memory 19 with small capacity, the Wi-Fi module upload driver 30b and the Bluetooth module upload driver 30a are essential to enable the Wi-Fi module 15 and the Bluetooth module 13, respectively. The processor 12 accesses the external non-volatile memory 17 and selectively extracts part of firmware driving data of the Wi-Fi and/or Bluetooth from the external non-volatile memory 17 to the internal volatile memory 18 or the internal non-volatile memory 19 in step S302. For example, the processor 12 extracts the Bluetooth peripheral mode firmware 40b and the Wi-Fi station mode firmware 41a as default from the external non-volatile memory 17. After the driving data is extracted, the extracted firmware driving data from the internal volatile memory 18 or the internal non-volatile memory 19 is uploaded to the Wi-Fi module 15 and/or the Bluetooth module 13 in step S303, respectively. After the driving data is uploaded, the processor 12 controls the Wi-Fi module 15 and/or the Bluetooth module 13 according to the extracted firmware driving data in routine in step S304. In step S305, the processor 12 detects whether the mode switch is triggered (i.e., if any mode switch signal is detected). Here, the mode switch triggered event can be defined as a Wi-Fi or Bluetooth operation adjustment, which can be observed by the corresponding variables, flags, or pin status. However, the present invention is not limited by using the above conditions to determine whether the mode switch is triggered. By observing the corresponding variables, flags, or pin status, if the mode switch is triggered, the processor 12 goes to the step S302. If the mode switch is not triggered, the process goes back to the step S304 or end process. By doing so, the wireless system package 300 can support various wireless operation modes and thus provides a multi-mode, convenient, and adaptive connection adjustment. The first serial number and the second serial number cab be two of a identify serial number of a SOC unit, a identify serial number of a processor, a serial number of an external non-volatile memory, a serial number of an the internal non-volatile memory, a serial number of a Wi-Fi module or a serial number of a Bluetooth module.

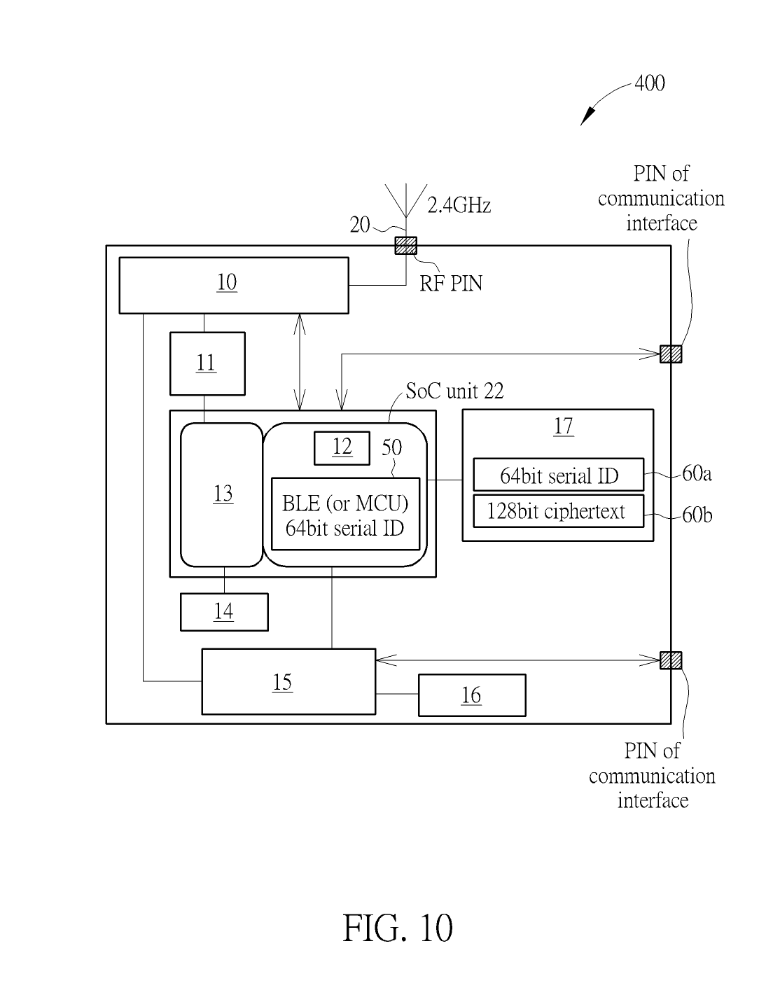

FIG. 10 illustrates a schematic block diagram of the wireless system package 400 according to an embodiment of the present invention. As shown in FIG. 10, a structure of the wireless system package 400 is similar to the wireless system package 100 in FIG. 1. The difference between the wireless system package 400 and the wireless system package 100 is that the security protection mechanism is introduced in the wireless system package 400. Specifically, the wireless system package 400 uses two unique serial numbers to implement the security protection. In the wireless system package 400, the first serial number (identifier) 50 is uniquely coded from the processor 12 of the SOC unit 22. The second serial number (identifier) 60a is uniquely coded from the external non-volatile memory 17. The ciphertext codeword (serial number) 60b is generated from the first serial number 50 and the second serial number 60a, and is saved to the external non-volatile memory 17 or the internal non-volatile memory 19. Here, a length of the first serial number 50 can be 64 bits. A length of the second serial number 60a can be 64 bits. A length of the ciphertext codeword 60b can be 128 bits. However, the embodiment is not limited by using the first serial number 50 with 64 bits, the second serial number 60a with 64 bits, and the ciphertext codeword 60b with 128 bits. For example, in other embodiments, the length of the first serial number 50, the length of the second serial number 60a, and the length of the ciphertext codeword 60b can be arbitrary. In the following, the security protection method of the wireless system package 400 is described.

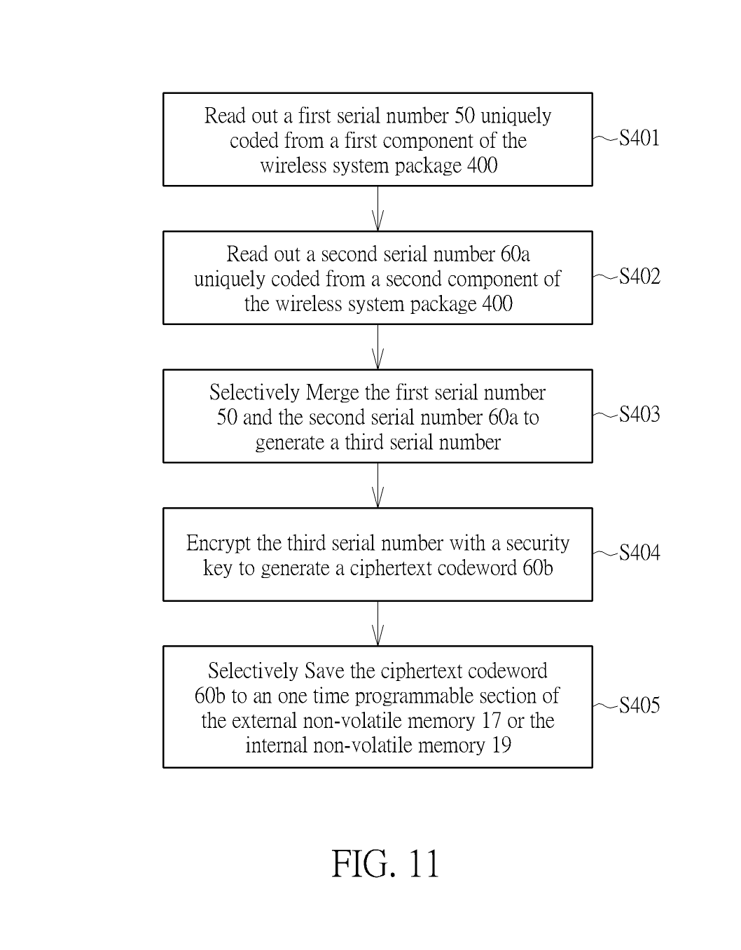

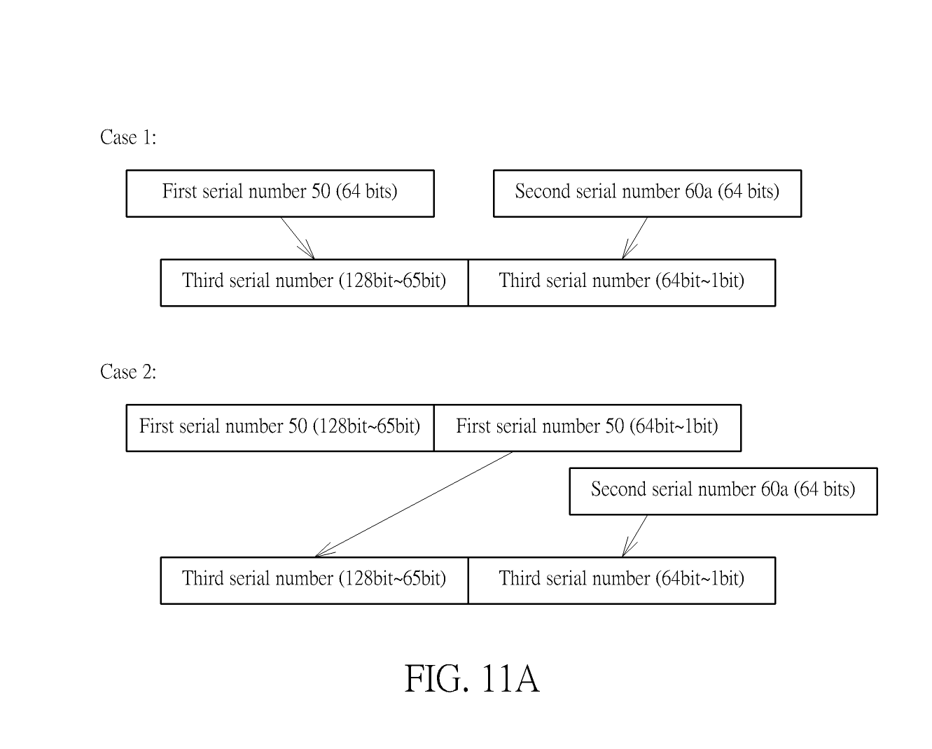

FIG. 11 illustrates a security protection method for the communication device or wireless system package 400 by encryption to generate a ciphertext codeword 60b according to an embodiment of the present invention. As shown in FIG. 11, the security protection method with respect to the encryption process includes step S401 to step S405, as illustrated below. The process can be encryption of a security protection program saving on the internal non-volatile memory 19 or the external non-volatile memory 17, and being executed on the processor 12.
step S401: Read out a first serial number 50 uniquely coded from a first component of the wireless system package 400;
step S402: Read out a second serial number 60a uniquely coded from a second component of the wireless system package 400;
step S403: Selectively Merge the first serial number 50 and the second serial number 60a to generate a third serial number;
step S404: Encrypt the third serial number with a security key to generate a ciphertext codeword 60b;
step S405: Selectively Save the ciphertext codeword 60b to an one time programmable section of the external non-volatile memory 17 or the internal non-volatile memory 19.

Here, the security protection for generating a ciphertext codeword 60b is processed before the wireless system package 400 is manufactured to an IC module product. In step S401, the first serial number 50 uniquely coded from a first component of the wireless system package 400 is read out. For example, the processor 12 of the SOC unit 22 (MCU) can read out the unique SOC 64-bit serial number 50 from the processor 12. In step S402, the second serial number 60a uniquely coded from a second component of the wireless system package 400 is read out. For example, the processor 12 of the SOC unit 22 reads out the unique 64-bit serial number 60a from the external non-volatile memory 17. In step S403, the processor 12 selectively merges the first serial number 50 and the second serial number 60a to generate a third serial number. When the first serial number 50 is the SOC 64-bit serial number 50 and the second serial number 60a is the 64-bit serial number 60a, a length of the third serial number is 128 bits. Then, according to step S404, the third serial number is encrypted with a security key to generate a ciphertext codeword 60b by an undisclosed or secretly encoded algorism. For example, the third serial number can be encrypted with the security key to generate a ciphertext codeword 60b by using AES128 encoded algorithm. However, the encrypted method in the present invention is not limited by using AES128 encoded algorithm. For example, the encrypted method can use symmetric encryption, such as Data Encryption Standard (DES), Triple DES (3 DES), IDEA, Blowfish, Twofish, RC4, RC5, RC6, AES (Advanced Encryption Standard). The encrypted method can use asymmetric encryption, such as RSA or Elliptic curve cryptography (ECC). Specifically, the asymmetric encryption uses a public key and a private key for achieving encryption and decryption processes. When the asymmetric encryption is applied to the security protection method for the communication device or the wireless system package 400, since the public key and the private key are distinct, the public key (or the private key) used for encryption in step S404, decryption requires a corresponding private key (or the public key) for decryption in step S505 (i.e., the decryption process is illustrated in the latter literature). The public key and the private key are regarded as a unique pair so that they can interchange for the encryption/decryption process in step S404 and step S505. Thus, when one security key (a public key in firmware or program) of the security key pair is unfortunately cracked by hackers, since no the other security key (private key) included the security key pair is provided by hackers, the decryption verification must be failed. As a result, the asymmetric encryption process can provide satisfactory security protection.

For presentation completeness, two cases of merging processes are illustrated in FIG. 11A. Consider the third serial number with sequence length equal to 128 bits. In case 1, the first serial number 50 with 64 bits can be generated to the sequence located on 128^{th} to 65^{th} bit address of the third serial number. The second serial number 60a with 64 bits can be generated to the sequence located on 64^{th} to 1^{st} bit address of the third serial number. In case 2, when the first serial number 50 has sequence length equal to 128 bits, a part of the first serial number 50 can be used to generate the partial sequence of the third serial number. For example, a sequence located on 64^{th} to 1^{st} bit address of the first serial number 50 can be generated to a sequence located on 128^{th} to 65^{th} bit address of the third serial number. Further, the second serial number 60a with 64 bits can be generated to the sequence located on the sequence located on 64^{th} to 1^{st} bit address of the third serial number. Finally, the generated ciphertext codeword 60b is saved to a specific memory segment (i.e., one time programmable section, OTP) of the external non-volatile memory 17 or the internal non-volatile memory 19 of the SOC unit 22. By doing so, the ciphertext codeword 60b is correlated to the first serial number 50 and the second serial number 60a. The correlation among the first serial number 50, the second serial number 60a, and the ciphertext codeword 60b can be used to protect the security of the wireless system package 400 from unlicensed, illegal, or pirate manufacturing. The protection method for using the ciphertext codeword 60b is illustrated below.

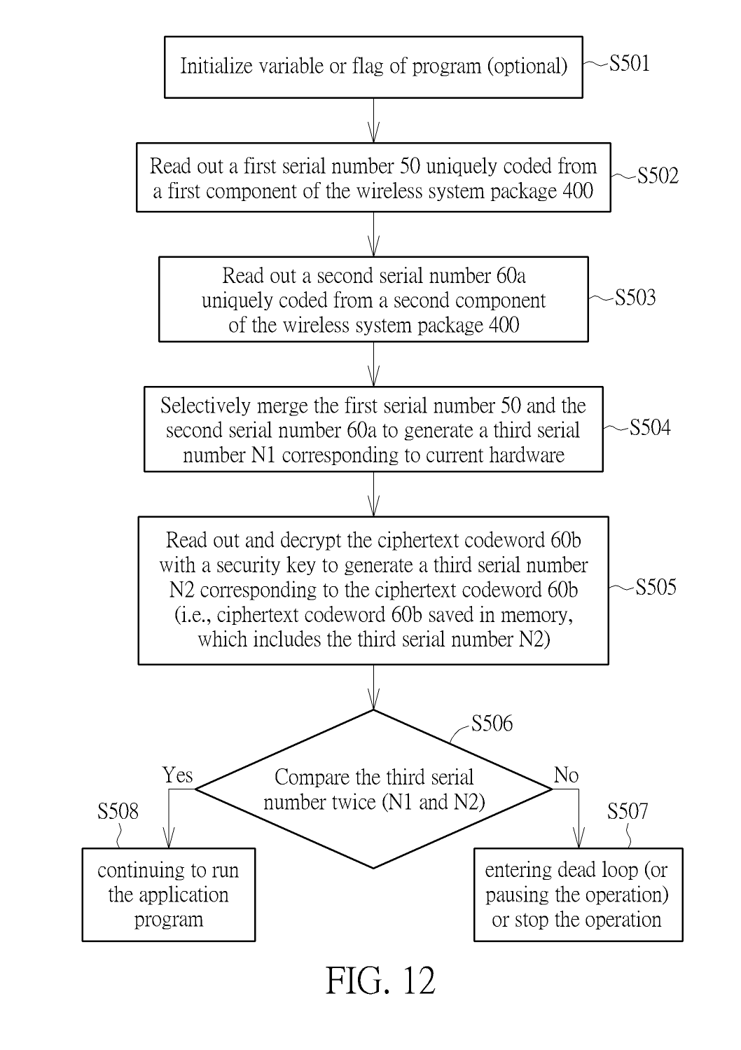

FIG. 12 illustrates a security protection method for the wireless system package 400 by verifying the ciphertext codeword 60a according to an embodiment of the present invention. As shown in FIG. 12, the security protection method for verifying the ciphertext codeword 60a includes step S501 to step S508, as illustrated below. The process can be verification of the security protection program saving on the internal non-volatile memory 19 or the external non-volatile memory 17, and being executed on the processor 12.
step S501: Initialize variable or flag of program (optional);
step S502: Read out a first serial number 50 uniquely coded from a first component of the wireless system package 400;
step S503: Read out a second serial number 60a uniquely coded from a second component of the wireless system package 400;
step S504: Selectively merge the first serial number 50 and the second serial number 60a to generate a third serial number N1 corresponding to current hardware;
step S505: Read out and decrypt the ciphertext codeword 60b with a security key to generate a third serial number N2 corresponding to the ciphertext codeword 60b (i.e., ciphertext codeword 60b saved in memory, which includes the third serial number N2);
step S506: Compare the third serial number twice (N1 and N2); If the security key matches with the third serial number twice (N1 and N2) (i.e. N1=N2), go to step S508; else go to step S507;
step S507: entering dead loop (or pausing the operation) or stop the operation (disable operation of the wireless system package 400);
step S508: continuing to run the application program.

Briefly, step S504 to step S506 is performed to compare or verify the consistency of the first serial number 50 and the second serial number 60a in the current hardware to the first serial number 50 and the second serial number 60a including the third serial numbers extracted from the ciphertext codeword 60b save in the external non-volatile memory 17 or the internal non-volatile memory 19. In another embodiment of the security protection method, step S505 can be changed to S505b that encrypts the first serial number 50 and the second serial number 60a in the current hardware with the security key to generate the ciphertext codeword corresponding to current hardware. Step S506 can be changed to S506b that reading out from ciphertext codeword 60b from the external non-volatile memory 17 or the internal non-volatile memory 19, and the ciphertext codeword corresponding to current hardware is compared to the ciphertext codeword 60b for determining whether two pairs of the first serial number and the second serial number are matched.

In the embodiment, security protection for generating a ciphertext codeword 60b is processed when the communication device or the wireless system package 400 is utilized by the vender's library, or an execution program (i.e., .exe file) is acquired by the user. In step S501, variable or flag of program are initialized. However, step S501 is an optional step and can be omitted in other embodiment. In step S502, the first serial number 50 uniquely coded from a first component of the wireless system package 400 is read out. For example, the processor 12 reads out the unique SOC 64-bit serial number 50 or the unique Bluetooth (BLE) 64-bit serial number 50 from the SOC unit 22 or the Bluetooth module 13. Specifically, different hardware components are extracted to different SOC 64-bit serial numbers 50. In step S503, the second serial number 60a uniquely coded from a second component of the wireless system package 400 is read out. For example, the processor 12 reads out the unique 64-bit serial number 60a from the external non-volatile memory 17. Specifically, different hardware components are extracted to different 64-bit serial numbers 60a. In step S504, the processor 12 selectively merges the first serial number 50 and the second serial number 60a to generate a third serial number N1 corresponding to current hardware. Then, in step S505, the processor 12 reads out and decrypts the ciphertext codeword 60b previously saved in the specific segment of the external non-volatile memory 17 or the internal non-volatile memory 19 (i.e., OTP section) with the security key to generating a third serial number N2 corresponding to the ciphertext codeword 60b. In step S506, the processor 12 compares the third serial number N1 and N2 twice, and detects twice whether the third serial number is matched. Specifically, when the communication device or the wireless system package 400 is utilized by the vender's library under a licensed software/hardware, the correlation among the ciphertext codeword 60b, the first serial number 50, and the second serial number 60a can be successfully verified. Then, the communication device or the wireless system package 400 continues to run the application program in step S508. On the contrary, when the communication device or the wireless system package 400 is utilized by the vender's library under an unlicensed software/hardware, or for duplicating in forms of unlicensed, illegal, or pirate manufacture, the verification of the correlation among the ciphertext codeword 60b, the first serial number 50, and the second serial number 60a will fail. As a result, the application program enters dead loop (or to pause the operation) or stop the operation by the security protection program in step S507. By doing so, the communication device or wireless system package 400 has a capability of security protection for any illegal utilization.

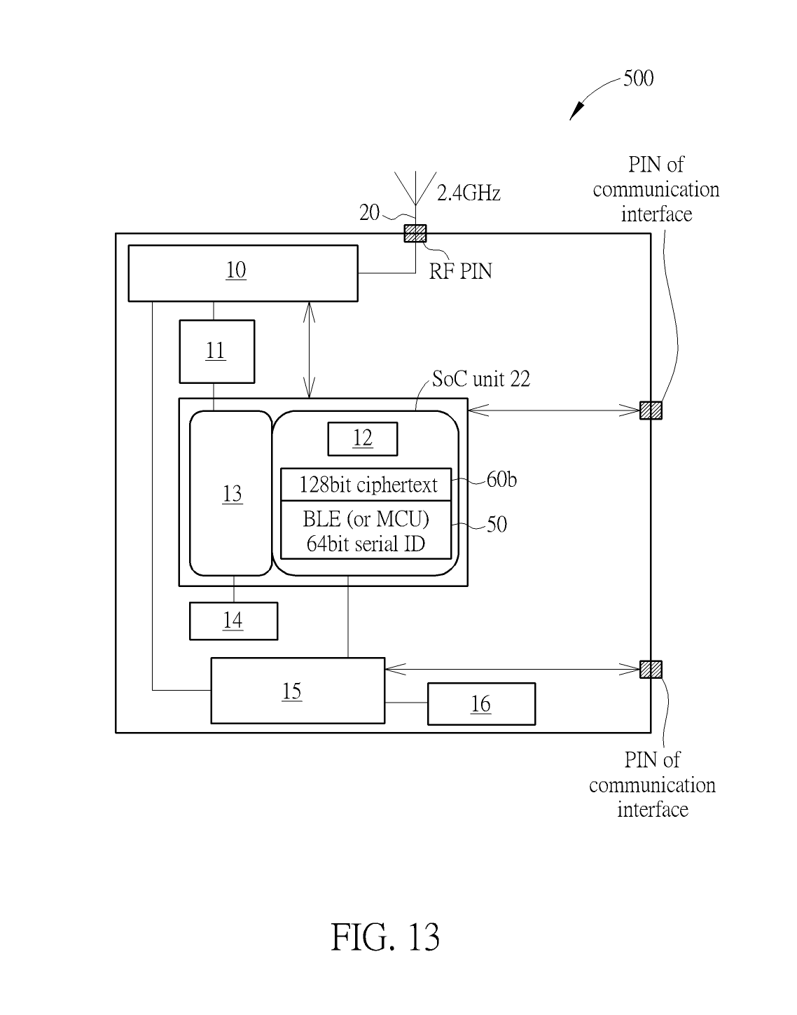

FIG. 13 illustrates a schematic block diagram of a wireless system package 500 according to an embodiment of the present invention. As shown in FIG. 13, the structure of the wireless system package 500 is similar to the wireless system package 400 in FIG. 10. The difference between the wireless system package 500 and the wireless system package 400 is that the ciphertext codeword 60b is saved to the memory segment (OTP) of the internal non-volatile memory 19. Since the wireless system package 500 does not have the external non-volatile memory 17, the ciphertext codeword 60b is only relevant to the first serial number 50 (i.e., unique SOC 64-bit serial number of the SOC unit 22 or unique Bluetooth (BLE) 64-bit serial number). In the embodiment, the first serial number 50 can be duplicated twice to generate a third serial number with a 128-bit serial length. Then, similar to wireless system package 400, the processor 12 encrypts the third serial number to generate a ciphertext codeword 60b (128 bits). Since the security protection method for the wireless system package 500 by decrypting and verifying the ciphertext codeword 60a is similar to the steps illustrated in FIG. 12, it is omitted here for brevity.

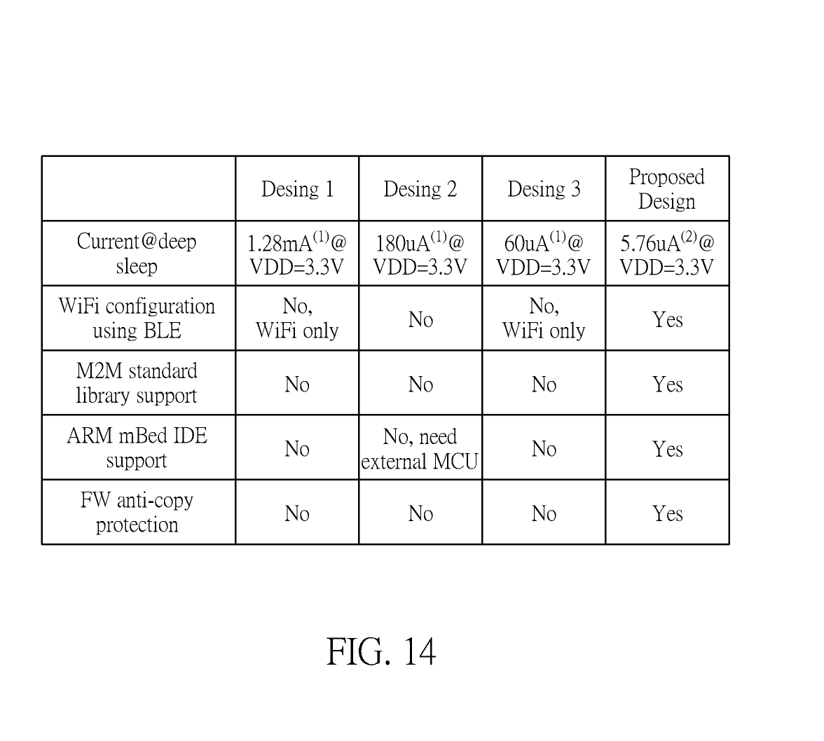

FIG. 14 illustrates a comparison between conventional communication devices and the wireless system package 100. As shown in FIG. 14, 6 types of the communication devices in conjunction with 5 operation functions are considered for comparison. The considered communication devices include design 1, design 2, design 3 and the proposed wireless system package 100. The considered operation functions include current deep sleep mode, Wi-Fi configuration using Bluetooth, machine to machine (M2M) standard library support, ARM embedded IDE support, and anti-copy protection. Specifically, the wireless system package 100 in the embodiments provides less operation current (5.76 uA) for deep sleep mode, supports Wi-Fi configuration by using Bluetooth signal, M2M standard library, ARM embedded IDE, and has a capability of anti-copy protection.

To sum up, the embodiments disclose a communication device or a wireless system package under internet of things network. The idea is to use an internal non-volatile memory with small capacity for providing multi-mode wireless operation. Specifically, Wi-Fi configuration of the communication device or wireless system package can be set by using Bluetooth signal thus reducing power consumption. The Wi-Fi configuration message propagation method is also introduced to facilitate the convenience of connection establishment. Further, a security protection is introduced for avoiding any duplicated, illegal, unlicensed or pirate manufacture. The wireless function circuit and components of the wireless system package are packaged together. Consequently, the wireless system package acts a package component and can be applied to a system circuit board of a general wireless communication device, such as wearable point-of-sale (POS) terminal or portable barcode scanner. The LO leakage of the wireless system package can be reduced easily and controlled precisely by adjusting isolation between RF pin and the wireless function circuit. Additionally, all techniques disclosed in the present invention can be also applied communication devices with different packages or non-package, thereby providing high flexibility and compatibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless system package, the wireless system package comprising:
a substrate comprising at least one layout, a plurality of pin pads on a bottom side of the substrate, a plurality of contact pads, and at least one via;
an external non-volatile memory being disposed on the substrate and coupled to the partial contact pads;
a first integrated circuit being disposed on the substrate and coupled to the partial contact pads, comprising:
a System on Chip (SOC) unit comprising a processor, an internal volatile memory and an internal non-volatile memory;
a bus coupled to the System on Chip unit;
a first clock unit configured to process a first clock from a first oscillator;
a first terminal coupled to the bus;
a second terminal coupled to the bus and the partial pin pads through at least one layout and configured to transmit and receive SOC data; and
a third terminal coupled to the System on Chip unit and a terminal of an external non-volatile memory through at least one layout;
a second integrated circuit being disposed on the substrate and coupled to the partial contact pad, comprising:
a second heterogeneous communication module;
a second clock unit configured to process a second clock from a second oscillator;
a first terminal coupled to the second heterogeneous communication module and the first terminal of the first integrated circuit through a layout of the substrate or a layout of a system printed circuit board (PCB); and
a second terminal coupled to the second heterogeneous communication module and configured to transmit and receive a second wireless signal;
wherein the first integrated circuit or the second integrated circuit comprises a first heterogeneous communication module configured to provide and process a first wireless signal, and a capacity of the external non-volatile memory is larger than a capacity of the internal non-volatile memory.

2. The wireless system package of claim 1, wherein the first heterogeneous communication module is a Bluetooth module and the second heterogeneous communication module is a Wi-Fi (Wireless Fidelity) module.

3. The wireless system package of claim 2, wherein the first terminal of the first integrated circuit and the first terminal of the second integrated circuit are together coupled to the partial pin pad through the at least one layout and configured to transmit and receive Wi-Fi data.

4. The wireless system package of claim 2, wherein the first terminal of the first integrated circuit and the first terminal of the second integrated circuit are coupled to different pin pads of the plurality of pin pads that are together coupled through the layout of the system PCB.

5. The wireless system package of claim 2, wherein the internal non-volatile memory or the external non-volatile memory comprises:
a Wi-Fi module upload driver firmware for initialing to drive the Wi-Fi module; and/or
a Bluetooth module upload driver firmware for initialing to drive the Bluetooth module.

6. The wireless system package of claim 1, further comprising:
a ciphertext codeword saved in an one time programmable section of the external non-volatile memory or the internal non-volatile memory.

7. The wireless system package of claim 1, wherein the external non-volatile memory comprising:
a plurality of firmware driving data of the Wi-Fi module; and/or
a plurality of firmware driving data of the Bluetooth module;
wherein the processor selectively extracts and uploads one of the plurality of firmware driving data of the Wi-Fi module to the Wi-Fi module and/or one of the plurality of firmware driving data of the Bluetooth module to the Bluetooth module, when the processor detects a mode switch signal.

8. A communication method for a communication device or a wireless system package, comprising:
the communication device or the wireless system package broadcasting an advertising signal;
the communication device or the wireless system package receiving a plurality of second parameters by Bluetooth corresponding to a second Wi-Fi (Wireless Fidelity) connection status from a first connection terminal or a second connection terminal; and
the communication device or the wireless system package establishing a connection Wi-Fi link to a second connection terminal according to the plurality of second parameters corresponding to the second Wi-Fi connection status.

9. The communication method of claim 8, further comprising:
the communication device or the wireless system package transmitting a plurality of first parameters corresponding to a first Wi-Fi connection status to the first connection terminal or the second connection terminal.

10. The communication method of claim 8, further comprising:
the communication device or the wireless system package transmitting the second Wi-Fi connection status back to the first connection terminal or the second connection terminal by Bluetooth after the communication device or the wireless system package successfully establishes the connection Wi-Fi link to the second connection terminal according to the plurality of second parameters.

11. The communication method of claim 8, further comprising:
the communication device or the wireless system package broadcasting an advertising signal of Bluetooth.

12. The communication method of claim 8, wherein the plurality of second parameters comprise an internet protocol (IP) address, a service set identifier (SSID) information, and a network security password.

13. The communication method of claim 8, further comprising:
the communication device or the wireless system package transmitting a Wi-Fi request signal to the second connection terminal before the communication device or the wireless system package establishes the connection Wi-Fi link to the second connection terminal according to the plurality of second parameters corresponding to the second Wi-Fi connection status.

14. The communication method of claim 8, further comprising:
the communication device or the wireless system package transmitting the plurality of second parameters by Bluetooth to at least one other communication device or the wireless system package within a Bluetooth transmitting coverage of the communication device or the wireless system package.

15. The communication method of claim 14, further comprising:
when the at least one other communication device or wireless system package is located within a Wi-Fi transmitted coverage of the second connection terminal and receives the plurality of second parameters, the at least one other communication device or wireless system package establishing a connection of Wi-Fi link to the second connection terminal according to the plurality of second parameters.

16. A communication method for a communication device or a wireless system package, comprising:
broadcasting a Wi-Fi Beacon signal;
receiving and advertising signal of Bluetooth from other communication device or wireless system package;
establishing a Bluetooth connection to the other communication device or wireless system package;
transmitting a plurality of second parameters by Bluetooth to the other communication device or wireless system package;
receiving a Wi-Fi (Wireless Fidelity) request signal with respect to the plurality of second parameters from the other communication device or wireless system package; and
verifying link validities and allowing to establish a Wi-Fi connection to the other communication device or wireless system package.

17. A security protection method for a communication device or a wireless system package, the method comprising:
reading out a first serial number uniquely coded from a first component of the communication device or the wireless system package;
reading out a second serial number uniquely coded from a second component of the communication device or the wireless system package;
reading out an ciphertext codeword from an non-volatile memory;
comparing or verifying a consistency between a first correlation and a second correlation; and
when the first correlation and the second correlation are inconsistency, disabling an operation of the communication device or the wireless system package;
wherein the first correlation is a correlation between the first serial number and the second serial number in a current hardware, the second correlation is a correlation between a first serial number and a second serial number with the ciphertext codeword saved in the non-volatile memory.

18. The method of claim 17, wherein the first serial number and the second serial number are two serial numbers of an identify serial number of a SOC unit, an identify serial number of a processor, a serial number of an external non-volatile memory, a serial number of an internal non-volatile memory, a serial number of a Wi-Fi module or a serial number of a Bluetooth module.

19. The method of claim 17, wherein comparing or verifying a consistency comprises:
selectively merging the first serial number and the second serial number to generate a third serial number corresponding to the current hardware;
decrypting the ciphertext codeword with a security key to generate a third serial number corresponding to the ciphertext codeword; and
comparing the third serial number twice, if the security key mismatches with the third serial number twice, disabling operation of the communication device or the wireless system package.

20. The method of claim 17, wherein comparing or verifying the consistency comprises:
encrypting the first serial number and the second serial number in the current hardware with a security key to generate the ciphertext codeword corresponding to current hardware; and
comparing the ciphertext codeword corresponding to the current hardware with the ciphertext codeword saved in the non-volatile memory for determining whether two pairs of the first serial number and the second serial number are matched.

21. The method of claim 17, wherein the ciphertext codeword read from the non-volatile memory is generated from a third serial number merged by the first serial number and the second serial number of the communication device or the wireless system package by a symmetric encryption algorithm or an asymmetric encryption algorithm.
